(19) United States
(12) Patent Application Publication
(10) Pub. No.: US 2020/0079922 A1
(43) Pub. Date: Mar. 12, 2020

(54) METHOD FOR PRODUCING FUNCTIONAL WATER SOLUBLE FILMS

(71) Applicant: BASF SE, Ludwigshafen am Rhein (DE)

(72) Inventors: Yannick Fuchs, Ludwigshafen (DE); Juergen Detering, Ludwigshafen (DE); Markus Meise, Ludwigshafen (DE); Helmut Witteler, Ludwigshafen (DE); Benjamin Schmidt-Hansberg, Ludwigshafen (DE); Claudia Esper, Ludwigshafen (DE); Marcel Schmitt, Ludwigshafen (DE); Maria De Moragas, Barcelona (ES)

(21) Appl. No.: 16/469,792

(22) PCT Filed: Dec. 7, 2017
(86) PCT No.: PCT/EP2017/081801

§ 371 Date: Jun. 14, 2019

(30) Foreign Application Priority Data
Dec. 16, 2016 (EP) 16204803.7

(51) Int. Cl. C08J 7/04; C08J 5/18; B29C 41/00; B29C 41/32

(52) U.S. Cl. CPC C08J 7/042; C08J 5/18; C08J 7/047; B29C 41/003; B29K 2071/00; C08J 2329/04; C08J 2429/04; C08J 2301/28; C08J 2401/28; B29C 41/32

(57) ABSTRACT

Described herein is a process for producing a water-soluble foil, wherein the water-soluble foil includes at least one layer S1) including a polymer composition P1) obtainable by free-radical polymerization of a monomer composition M1) including at least one monomer A) selected from α,β-ethylenically unsaturated mono- and dicarboxylic acids, salts of α,β-ethylenically unsaturated mono- and dicarboxylic acids, anhydrides, of α,β-ethylenically unsaturated mono- and dicarboxylic acids and mixtures thereof, in the presence of at least one polyether component PE) selected from polyetherols having a number-average molecular weight of at least 200 g/mol, mono- and di(C₁-C₆-alkyl) ethers of such polyetherols, surfactants containing polyether groups, and mixtures thereof, where the foil may also include further layers, and where the layers are cast onto a carrier material.

### FIELD OF INVENTION

The present invention relates to a process for producing water-soluble foils, wherein the water-soluble foil comprises at least one layer S1) comprising or consisting of a polymer composition P1) obtainable by free-radical polymerization of a monomer composition M1) comprising at least one monomer A) selected from α,β-ethylenically unsaturated mono- and dicarboxylic acids, salts of α,β-ethylenically unsaturated mono- and dicarboxylic acids, anhydrides, of α,β-ethylenically unsaturated mono- and dicarboxylic acids and mixtures thereof, in the presence of at least one polyether component PE) selected from polyetherols having a number-average molecular weight of at least 200 g/mol, mono- and di(C₁-C₆-alkyl) ethers of such polyetherols, surfactants containing polyether groups, and mixtures thereof, wherein the foil may also comprise further layers, and wherein the layers are cast onto a carrier material.

### BACKGROUND

It is known that water-soluble foils of polyvinyl alcohol can be used for packaging of washing and cleaning compositions and also for agrochemical formulations in liquid, gel and solid form as portions. The polyvinyl alcohol foil dissolves at the start of the washing and cleaning process and releases the washing and cleaning compositions, and so they are able to display their effect. The advantages of the washing and cleaning compositions packaged as portions (called single dose units or mono dose units) for the consumer are manifold. These include the avoidance of incorrect dosages, ease of handling, and the fact that the consumer does not come into physical contact with the constituents of the washing and cleaning compositions. These additionally also include esthetic aspects which lead to a preference for the washing and cleaning compositions packaged as portions. Current dosage forms can comprise a large number of separately formulated active ingredients and auxiliaries which are released individually in the cleaning process. Such multichamber systems permit, for example, the separation of incompatible constituents and hence the creation of new formulation concepts. The proportion of the polyvinyl alcohol foil in the total weight of the washing or cleaning composition portion (single dose unit) is between 2% and 20% by weight, according to the application.

One disadvantage of the polyvinyl alcohol foils is that they merely serve as packaging material and make no contribution at all to the washing and cleaning performance. There is therefore a need for washing- and cleaning-active polymer foils.

Lev Bromberg describes, in the Journal of Physical Chemistry B (1998), 102, 11, 1956-1963, a material with thermoreversible gel formation, the production of which involves polymerizing acrylic acid in the presence of a PEO-PPO-PEO block copolymer. The reaction proceeds in the absence of external solvents in order to achieve a high proportion of branching and crosslinking in the resultant products. These are neither water-soluble nor transparent. Possible fields of use mentioned for these polymers are only very generally pharmacy and food supplements (p. 1956, left-hand column, “Introduction”).

Lev Bromberg describes, in Ind. Eng. Chem. Res. 1998, 37, 4267-4274, polyether-modified polyacrylic acids, specifically by polymerization of partly neutralized acrylic acid in the presence of a PEO-PPO-PEO block copolymer.

WO 2005/012378 describes aqueous dispersions of water-soluble polymers of anionic monomers and the use thereof as thickeners for aqueous systems. To produce them, anionic monomers are polymerized in the presence of two water-soluble polymers from different classes, which may, inter alia, also be polyalkylene glycols. Example 4 (page 19, lines 14-27) relates to the polymerization of acrylic acid in the presence of two different polypropylene glycols and of maltodextrin. The dispersions are used inter alia in personal care products, and in washing and cleaning compositions. There is no description of use in the form of foils.

WO 2015/000969 describes the use of a polymer composition in gel form, obtainable by a process in which
a) a monomer composition M1) is provided, consisting of
A) at least one α,β-ethylenically unsaturated acid, and
B) 0% to 0.1% by weight, based on the total weight of monomer composition M1), of crosslinking monomers having two or more than two polymerizable α,β-ethylenically unsaturated double bonds per molecule,
b) monomer composition M1) provided in step a) is subjected to a free-radical polymerization in the presence of at least one polyether component PE) selected from polyetherols having a number-average molecular weight of at least 200 g/mol and the mono- and di(C₁-C₆-alkyl ethers) thereof, surfactants containing polyether groups, and mixtures thereof.
   in formulations for machine dishwashing. Again, there is no description of use in the form of foils.

WO 2015/000971 describes the use of a polymer composition in gel form as described in WO 2015/000969 for further uses, but not in the form of foils.

WO 2015/000971 describes a process for producing a solid polymer composition, especially in the form of a foil or in the form of a solid coating on a substrate or in particle form, in which
a) a monomer composition M1) is provided, comprising
A) at least one α,β-ethylenically unsaturated carboxylic acid, and
B) less than 0.1% by weight, based on the total weight of monomer composition M1), of crosslinking monomers having two or more than two polymerizable α,β-ethylenically unsaturated double bonds per molecule,
   and
b) monomer composition M1) provided in step a) is subjected to a free-radical polymerization in the presence of at least one polyether component PE) selected from polyetherols having a number-average molecular weight of at least 200 g/mol and the mono- and di(C₁-C₈-alkyl ethers) thereof, surfactants containing polyether groups, and mixtures thereof.

WO 01/00781 describes an active ingredient portion pack comprising at least one washing-, cleaning- or dishwashing-active preparation and an envelope fully or partly enveloping the washing-, cleaning- or dishwashing-active preparation, in which the envelope is soluble under washing, cleaning or dishwashing conditions and comprises at least one individual component of the washing-, cleaning- or dishwashing-active preparation in bound form. It is not stated that the material of the envelope itself actively participates in the washing or cleaning operation.

EP 16160745.2 relates to a monolaminar washing- and cleaning-active polymer foil, comprising or consisting of a polymer composition P1) obtainable by free-radical polymerization of a monomer composition M1) comprising at least one monomer A) selected from α,β-ethylenically unsaturated carboxylic acids, salts of α,β-ethylenically unsaturated carboxylic acids and mixtures thereof, in the presence of at least one (C₈-C₁₈-alkyl)polyoxyalkylene ether having an average of 3 to 12 alkylene oxide units per molecule. Also described are a process for producing such a washing- and cleaning-active polymer foil, the use of such a polymer foil and a sheath or coating for a washing or cleaning composition portion comprising or consisting of such a polymer foil. There is no description of multilaminar polymer foils.

It is known that multilayer foils having a layer construction composed of at least two foil laminas can be provided.

WO 2010/069553 describes a multilayer foil comprising an at least flushable thermoplastic layer construction composed of

A) at least one layer which can at least be broken up by the action of water and is resistant to cold water or can be dissolved relatively slowly therein, based on at least one at least partly hydrolyzed polyvinyl acetate, and
B) at least one cold water-soluble layer based on at least one at least partly hydrolyzed polyvinyl acetate and at least one water solubility-enhancing substance selected from the group comprising biodegradable polymers, surfactants, inorganic pigments and fillers.

A flushable layer construction is understood to mean that resulting packages do not cause blockages in drains in the event of flushing with water, for example a toilet flush. They serve as protective packaging for a wide variety of different goods, such as washing compositions or dishwashing compositions packaged in individual portions (for example in the form of tabs), and for hygiene articles such as tampons or sanitary napkins which are used together with the flushable packaging. After the removal of the packaging for use of these articles, the packaging can be disposed of by simply flushing it away with the aid of a toilet flush.

U.S. Pat. No. 7,727,946 describes a process for producing functionalized films for cleaning products, wherein a water-soluble film bears a coating of a composition that exerts a particular function. For this purpose, an aqueous solution of a functional material is applied stepwise on at least one side of the water-soluble film, in order to produce a multilayer coating on the film. For this purpose, each layer applied is allowed to at least partly dry before the next layer is applied. Each layer may comprise different functional materials with cleaning properties, barrier properties and/or solubility-modifying properties. In addition, the aqueous solution comprises an agent that temporarily reduces the solubility of the water-soluble film, such that it is wetted but does not dissolve or swell. The individual layers are preferably applied by a printing method such as flexographic printing. Suitable film-forming polymers mentioned are polyvinyl alcohols, polyvinylpyrrolidones, polyalkylene oxides, polyacrylamides, polyacrylic acids, cellulose, cellulose ethers, cellulose esters, cellulose amides, polyvinyl acetates, polycarboxylic acids and salts thereof, polyamino acids, polyam ides, polyacrylam ides, maleic/acrylic acid copolymers, polysaccharides and mixtures thereof. Particular preference is given to using polyvinyl alcohol films commercially available under the Monosol M8630 name, for example. Agents used that temporarily reduce the solubility of the water-soluble film are salts such as sodium sulfate, sodium citrate, etc. There is no description of application of the functional materials together with film-forming polymers.

The prior art does not disclose the provision or production of a foil having a film-forming functional polymer composition that has dispersing, film-inhibiting, emulsified and/or surfactant properties and hence contributes to washing and cleaning performance and is suitable for storage-stable formulation. Nor is there any disclosure of an efficient process for producing such a foil.

The disadvantages apparent from the prior art are solved by the subject matter of the invention as described herein and defined in the claims.

### DESCRIPTION

The present invention relates to a process for producing a functional water-soluble foil, wherein the water-soluble foil comprises at least one layer S1) comprising or consisting of a polymer composition P1) obtainable by free-radical polymerization of a monomer composition M1) in the presence of at least one polyether component PE), wherein M1) comprises at least one monomer A) selected from α,β-ethylenically unsaturated mono- and dicarboxylic acids, salts of α,β-ethylenically unsaturated mono- and dicarboxylic acids, anhydrides, of α,β-ethylenically unsaturated mono- and dicarboxylic acids and mixtures thereof, in the presence of at least one polyether component PE) selected from polyetherols having a number-average molecular weight of at least 200 g/mol, mono- and di(C₁-C₆-alkyl) ethers of such polyetherols, surfactants containing polyether groups, and mixtures thereof,

wherein the process comprises the following steps:
(a) preparing an aqueous solution of the polymer composition P1), where the aqueous solution may comprise, as well as or in place of water, alcohol such as 2-propanol inter alia,
(b) casting the aqueous polymer composition P1) from (a) as a film onto a carrier material,
(c) optionally drying the film after the applying of S1) to the carrier material,
(d) optionally applying a layer S2),
   wherein layer S2) comprises at least one polymer P2) or consists of at least one polymer P2) which is different than the polymer composition P1) and is selected from
   natural and modified polysaccharides,
   homo- and copolymers comprising repeat units which derive from vinyl alcohol, vinyl esters, alkoxylated vinyl alcohols or mixtures thereof,
   homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
   homo- and copolymers of acrylic acid and/or methacrylic acid, especially copolymers comprising at least one copolymerized acrylic monomer selected from acrylic acid, acrylic salts and mixtures thereof, and at least one copolymerized maleic monomer selected from maleic acid, maleic anhydride, maleic salts and mixtures thereof,
   copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
   copolymers comprising at least one copolymerized maleic monomer selected from maleic acid, maleic anhydride, maleic salts and mixtures thereof and at least one copolymerized C₂-C₈ olefin,
   homo- and copolymers of acrylamide and/or methacrylamide,
   polyamino acids,
   water-soluble or water-dispersible polyamides,
   polyalkylene glycols, mono- or diethers of polyalkylene glycols,
   polyalkylene oxides, for example polyethylene oxide, and
   mixtures thereof,
   (e) optionally drying the film after the applying of S2) to the carrier material,
   (f) optionally applying one or more further layers S1) and/or S2),
   (g) optionally drying the film after the applying of one or more further layers S1) and/or S2) to the carrier material in (f),
      drying the foil after the applying of all layers S1) and S2) to the carrier material, wherein layers S1) and/or S2) may be applied in a freely chosen sequence or else simultaneously and in each case optionally dried after every application of one or more layers.

C₁-C₆ Alkyl in the mono- and di(C₁-C₆-alkyl) ethers defined here for PE) represents alkyls having 1 to 6 carbon atoms that form linear or branched alkyls.

In one embodiment of the present invention, layer S2), after the drying of the film after the applying of S2) to the carrier material (step (e)), is combined with a second dilaminar foil in the manner of a lamination.

The second dilaminar foil may be produced simultaneously in steps (a) to (d) beforehand or in a parallel plant. If the same composition has been used for the laminas of the two foils that are in contact, the multilaminar foil produced via lamination in this way consists of three chemically different laminas.

In a further embodiment of the present invention, the dilaminar foil produced in steps (a) to (d) is cut in the middle in machine direction; subsequently, the two halves of the foil obtained are laminated.

In this embodiment, it is also possible to laminate the chemically identical interfaces to one another in order to effectively obtain three chemically different laminas.

The advantage of the two abovementioned embodiments of the present invention is distinctly accelerated drying as a result of the reduced layer thickness, which correlates directly with an elevated production rate. Without being restricted to the theory, the mass transfer of the solvent through the film with a constant coefficient of diffusion is proportional to 1/film thickness.

In one embodiment of the present invention, the foil does not comprise any crosslinkers.

According to the invention, however, it is also possible that all layers S1) and S2) of the foil to be produced in accordance with the invention may also comprise plasticizers known to those skilled in the art. Suitable plasticizers include, for example, alkyleneamines, alkanolamines, polyols such as alkylene glycols and oligoalkylene glycols, e.g. 2-methylpropane-1,3-diol, 3-methylpentane-1,5-diol, hydroxypropylglycerol, neopentyl glycol, alkoxylated glycerol (for example Voranol® from Dow Chemicals), water-soluble polyesterpolyols (for example TriRez from Geo Specialty Chemicals) and mixtures thereof. Suitable plasticizers are also polyetherpolyols available under the Lupranol® name from BASF SE. The term “alkyleneamines” refers to condensation products of alkanolamines with ammonia or primary amines; for example, ethyleneamines are obtained by reaction of monoethanolamine with ammonia in the presence of a catalyst. This results in the following main components: ethylenediamine, piperazine, diethylenetriamine and aminoethylethanolamine.

Preferably, the plasticizers are selected from glycerol, diglycerol, propylene glycols having a weight-average molecular weight of up to 400, ethylene glycol, polyethylene glycols having a weight-average molecular weight of up to 400, diethylene glycol, triethylene glycol, tetraethylene glycol, sugar alcohols such as sorbitol, mannitol, xylitol, isomalt, lactitol, isopentyldiol, neopentyl glycol, trimethylolpropane, diethylenetriamine, triethylenepentamine, ethanolamine, diethanolamine, triethanolamine and mixtures thereof.

In order to make the foils to be produced in accordance with the invention more resistant to aggressive ingredients (for example chlorine-releasing compounds as used in the field of disinfection of water, etc.), it is additionally also possible in the context of the present invention to add what are called “scavengers” (capture molecules) to the foil, such that they are present in S1) and/or S2). Suitable scavengers include, for example, polyamines, polymeric polyamines, such as polyethyleneimines, poly(amidoamines) and polyamides. In addition, it is also possible to use ammonium sulfate, primary and secondary amines having a low vapor pressure, such as ethanolamines, amino acid and salts thereof, and also polyamino acid and salts thereof, fatty amines, glucosamines and other aminated sugars. It is further possible to use reducing agents, such as sulfites, bisulfites, thiosulfites, thiosulfates, iodides, nitrites and antioxidants such as carbamates, ascorbates and mixtures thereof.

Layers S1 and/or S2 of the foils to be produced in accordance with the invention may, as well as plasticizers and/or scavengers as described here by way of example, also comprise further polymers, gas permeability and water vapor permeability modifiers, antistats, lubricants, slip agents, dissolution auxiliaries, dyes, pigments, enzymes, corrosion inhibitors, defoamers, fragrances, thickeners, solubilizers, solvents, pH adjusters, antiredeposition agents, optical brighteners, graying inhibitors, dye transfer inhibitors, active antimicrobial ingredients, antioxidants, UV absorbers, antiyellowing agents, bitter substances (e.g. Bitrex®) and/or mixtures thereof.

In general, the step of dissolving the polymer composition P1) in water also includes the water already present in the polymer composition, and so there is not necessarily any need here to add water if water is already present in the polymer composition, preferably sufficient water to dissolve the polymer composition.

The terms “foil” and “film” are used synonymously hereinafter to the extent that each describes a coherent two-dimensional extent of a composition comprising polymer composition P1), although the term “foil” additionally includes mechanical durability, which need not necessarily exist in the case of the term “film”, especially not prior to appropriate drying.

It has been found in the context of the present invention that a polymer composition P1) obtainable by free-radical polymerization of a monomer composition M1) comprising at least one monomer A) selected from α,β-ethylenically unsaturated mono- and dicarboxylic acids, salts of α,β-ethylenically unsaturated mono- and dicarboxylic acids, anhydrides, of α,β-ethylenically unsaturated mono- and dicarboxylic acids and mixtures thereof, in the presence of at least one polyether component (PE) selected from polyetherols having a number-average molecular weight of at least 200 g/mol, mono- and di(C₁-C₆-alkyl) ethers of such polyetherols, surfactants containing polyether groups, and mixtures thereof is suitable, when cast onto a suitable carrier material, for forming a foil (or a film at first) that has not just mechanical durability but, because of its composition, in particular, functional properties, such as dispersing, film-inhibiting, complexing, emulsifying, surface-modifying and/or surfactant properties. A further advantage of the current invention is that the foil can be elaborated as a multilayer foil by casting multiple and optionally different layers, for example S1) and/or S2) as described and defined here, one on top of another. What is remarkable and surprisingly here is that such a multilayer foil can be cast without needing to dry off the respective layer beneath in between. Thus, it is also possible to cast two or more layers simultaneously, for example by means of a multislot die, or first to cast one or more layers and then, without intermediate active drying, to cast one or more further layers on top. However, intermediate drying steps can be conducted in order to achieve an increase in viscosity of the layer(s) to be dried.

The foils to be used in accordance with the invention are especially suitable for use in washing and cleaning compositions. For this purpose, individual components of a washing or cleaning composition or else a complete washing or cleaning composition may be formulated in the form of a multilayer foil. A washing or cleaning composition in the form of a multilayer foil dissolves at the start and/or in the course of the respective use (for example in the washing or rinse water), thus releases the constituents of the washing and cleaning composition and, in dissolved form, because of the dispersing, film-inhibiting, complex-forming, emulsifying and/or surfactant properties of the polymer composition P1) present, contributes considerably to the washing and cleaning performance.

The foils to be used in accordance with the invention are also suitable for packaging of washing and cleaning compositions in liquid, gel and solid form as portions. They dissolve at the start and/or in the course of the respective use (for example in the washing or rinse water), thus release the constituents of the washing and cleaning composition and, in dissolved form, because of the dispersing, film-inhibiting, complex-forming, emulsifying and/or surfactant properties of the polymer composition P1) present, contribute considerably to the washing and cleaning performance.

In the context of the present invention, the terms “washing composition portion” and “cleaning composition portion” are understood to mean an amount of a washing composition or cleaning composition sufficient for a washing or cleaning operation that takes place in an aqueous phase. This may, for example, be a machine washing operation as conducted with commercial washing machines. According to the invention, this term is also understood to mean an active ingredient portion for a handwashing operation or a cleaning operation conducted manually (as conducted, for example in a handwash basin or in a bowl). The washing- and cleaning-active multilayer foils of the invention are preferably used for production of active ingredient portions for machine washing or cleaning operations.

The foil for use in accordance with the invention has the great advantage of being functional in character itself, i.e. of not merely imparting mechanical stability like the polyvinyl alcohol foils used as standard, for example, in pouches, pods or the like, since the foil layer S1) already includes functional constituents such as polymers and surfactants in particular. It is additionally also part of the present invention that there may be further layers that comprise further functional constituents (for example builders, polymers, enzymes, etc.) and/or impart further mechanical stability (for example polyvinyl and (PVA or PVOH hereinafter) or others as described here). It is also possible for the different layers each to have different dissolution capacities; for example, the water solubility of the individual layers of the foil to be produced in accordance with the invention may be adjusted in accordance with the performance requirements. The different solubility may therefore vary, for example, depending on temperature (different junctures in the washing or rinsing operation) and/or pH.

In a preferred embodiment, the individual layers of the multilayer foils of the invention are water-soluble or water-dispersible. According to the field of use of the multilayer foils of the invention, it may be advantageous for the individual layers to have a particular solubility in water. For example, it may be desirable for different layers to have different solubility in water. It may also be desirable, for example, for an outer surface layer to have a lesser degree of water solubility in order to prevent blocking and/or partial dissolution in the event of high air humidity and/or high contact moisture (e.g. hand moisture). Alternatively, it may also be desirable for an outer surface layer to have high water solubility in order to rapidly release an active ingredient present therein or ensheathed therewith on contact with water. In particular fields of use, it may be advisable, for safety reasons, to enable release on contact with water within not less than 30 seconds in order to prevent dissolution in the mouth in the event of inadvertent or unwanted oral intake. These or similar limits are also legally stipulated in various countries and should be correspondingly noted. Such a foil may then have water-insoluble outer packaging to prevent unwanted contact with water.

According to the field of use of the multilayer foils of the invention, it may also be advantageous for the individual layers to have a temperature-dependent solubility in water.

In the casting of the polymer composition P1) onto a suitable carrier material as described and defined here, it is not absolutely necessary for the polymer composition P1) to have already polymerized fully on casting. On the contrary, it is likewise possible in the context of the present invention that the polymer composition P1), on casting onto the carrier material as described and defined here, has polymerized only partly, if at all, and polymerizes fully only during casting and/or after casting. In one embodiment of the present invention, the aqueous polymer composition P1) has already polymerized fully on casting onto the carrier material.

As already stated, the polymer composition P1), in accordance with the invention, before being cast onto a carrier material, is dissolved in water or is already dissolved after the preparation process. The dissolving in water is ideally effected in such a way that there is no formation of multiple phases in the aqueous polymer composition P1). This is known to the person skilled in the art and can especially be achieved by a reduced dissolution rate (addition of water to the polymer composition P1) or vice versa) and gentle mixing (such as low mixing speed, for example low rotation rate in the case of mixing by means of an impeller). According to the invention, the concentration of the aqueous polymer composition P1) prior to casting is at least about 40 w/w %, at least 45 w/w %, at least 50 w/w %, or at least 55 w/w %, based in each case on the total mass of polymer composition P1) and water, preferably based on the total mass of the proportion of nonvolatile polymer composition P1) and water. The temperature of the solution should be chosen such that no bubbles form. This is known to the person skilled in the art and can be achieved, for example, in that a maximum temperature of not more than 90° C., for example about 40 to 90° C. or 60 to 90° C., is applied. Bubble formation can also result, for example, from reduced pressure and simultaneous or subsequent degassing of the solution and can be correspondingly avoided. In one embodiment, the temperature at which the aqueous polymer composition P1) is cast onto the carrier material may be about 40 to 90° C., or else lower, for example max. about 90° C., max. about 60° C., or max. about 40° C. The concentration of the aqueous polymer composition P1) and the temperature can each be varied in order to achieve a desired viscosity of the aqueous polymer composition P1). In the context of the present invention, the viscosity of the aqueous polymer composition P1) is preferably adjusted prior to casting such that it can be cast easily without leaving the carrier material (i.e. running out of the carrier material) after the casting, and at the same time allows both homogeneous distribution of the foil on the carrier material and easy intermediate or final drying of the foil formed. The desired viscosity is especially also dependent on the manner in which the polymer composition P1) is cast onto the carrier material, by methods including through a die, for example slot die, cascade die, curtain coating or others, where the slot die may also have multiple slots (e.g. 1, 2 or 3 slots) in order to permit simultaneous casting of multiple layers. For instance, in the context of the present invention, for example on casting by means of a slot die, a viscosity of aqueous polymer composition P1) of about max. 30 Pa*s, max. 20 Pa*s or max. 10 Pa*s may be advantageous (according to the size of the die opening as well), especially when just one layer is being cast at any time. In cascade casting, i.e. when two or more layers are applied simultaneously, in the context of the present invention, a viscosity of the aqueous polymer composition P1) of only max. about 1 Pa*s, max. 500 mPa*s or max. 350 mPa*s may be advantageous. The person skilled in the art will be able to vary the viscosity here appropriately (via concentration and temperature of the aqueous polymer composition P1) inter alia; see above), in order to adapt to the further parameters such as casting methodology, subsequent drying and foil purpose. Testing methods for viscosity are known to those skilled in the art and include, for example, cone-plate rheometry to DIN 53019, for example at a temperature of about 25° C. and a shear rate of 1/100 s⁻¹, or by high-pressure capillary rheometry to DIN 54811.

The multilaminar foil can be applied to a steel belt or a heated roll via mono- or multilaminar casting or coating tools, for example slot dies, coating bars, curtain coating, cascade casting, etc. It is possible here to apply one or more laminas simultaneously and the further laminas, as desired, at a different position on the steel belt or the roll. In a further execution, a further laminar may be applied in a further drying step atop the exposed film after the detachment from the carrier (steel belt or roll). Roll-based coating methods in particular are suitable for this further coating operation.

In a further execution, it is also possible to combine multiple steel belt or roll drier systems in such a way that two separately produced mono- or multilaminar foils are bonded to one another directly thereafter in a lamination step. This step may also be conducted with a previously produced or commercially available foil. The step of laminating the foils can be conducted before a foil has been pulled off, immediately after the foil has been pulled off and prior to the further drying of the exposed foil, during the further drying of the exposed foil or after the further drying, but prior to the foil winding. Separately conducted lamination of two foils is also possible. In all variants of lamination, lamination is possible solely via controlled adjustment of the residual moisture content in the foil and correspondingly chosen line loads.

According to the invention, the casting of the aqueous polymer composition can be effected by different techniques, including by means of dies, for example slot die, cascade die, curtain coating, or others, where the slot die may also have multiple slots (e.g. 1, 2 or 3 slots) in order to allow simultaneous casting of multiple layers. The die may also itself be heated in order to maintain the desired temperature of the aqueous polymer composition P1) at the juncture of casting onto the carrier material. According to the invention, preferred temperatures here are max. about 90° C., preferably max. about 60 or 40° C. Suitable materials of which the die consists or which the die comprises in the context of the present invention include steel alloys (e.g. austenitic steel, stainless steel, passivated steel (Römpp Online, Version 3.5, Georg Thieme Verlag 2009), steel alloys, for example according to AISI/SAE/DIN EN 10088; for example steel comprising about 10% to 22% (or 12% to 20%, 13% to 17%) by weight of chromium, for instance 0.02% to 0.2% (or 0.05% to 0.15% or 0.05% to 0.12%) by weight of carbon, and/or about 9% to 15% by weight of nickel, optionally also including manganese, molybdenum, vanadium and/or titanium), titanium alloys, tungsten carbide, corrosion-resistant alloys (e.g. MAT with about 19-22% by weight of nickel, 18-20% by weight of molybdenum, 1-2% by weight of titanium), and/or Hastelloy.

The casting of a polymer P2) to form a layer S2) can generally be effected analogously to the manner described here for the casting of polymer composition P1) to form layer S1).

The carrier material onto which the aqueous polymer composition P1) is cast in the context of the present invention consists of a material which permits foil formation and optionally polymerizing and optionally drying of the foil. The carrier material may be arranged here as a continuous belt or conveyor belt which moves onward under the casting apparatus (for example die as described here and shown by way of example) in the course of the casting operation in order to accommodate the cast aqueous polymer composition P1) as foil. Such configurations are shown here too by way of example and in the figures. It is also possible to cast the aqueous polymer composition P1) onto the carrier material under reduced pressure conditions compared to the ambient pressure of the casting apparatus (for example nozzle), for example in that a reduced pressure chamber is connected upstream of the nozzle such that less air is entrained into the casting operation, as also described and shown by way of example in FIG. 10.

“Carrier material” in connection with the invention is understood to mean that material onto which the aqueous polymer composition P1) is cast. It is also possible that the carrier material is atop another material, but one that, according to the invention, does not itself come into contact with the aqueous polymer composition P1). For example, it may be the case that the aqueous polymer composition P1) is cast onto a polyvinyl alcohol layer which is itself on a continuous steel belt. The carrier material in the context of the present invention in that latter case would be the polyvinyl alcohol layer.

Suitable carrier materials in the context of the present invention may, for example, be metallic carrier materials, a layer S2) and/or else a preceding layer S1) as described further here, nonwovens and/or other polymers. “Metallic carrier materials” comprise or consist, for example, of aluminum, iron alloys such as steel (e.g. austenitic steel, stainless steel, passivated steel (Römpp Online, Version 3.5, Georg Thieme Verlag 2009), steel alloys, for example according to AISI/SAE/DIN EN 10088; for example steel comprising about 10% to 22% (or 12% to 20%, 13% to 17%) by weight of chromium, for instance 0.02% to 0.2% (or 0.05% to 0.15% or 0.05% to 0.12%) by weight of carbon, and/or about 9% to 15% by weight of nickel, optionally also including manganese, molybdenum, vanadium and/or titanium). “Metallic carrier materials” are preferably rust-free or very substantially rust-free (stainless steel). Polymers as carrier materials may comprise or consist, for example, of those as described here as layer S2) or else S1). Carrier materials may also comprise or consist, inter alia, of oriented polypropylene (PP), polyethylene (PE), polystyrene (PS), polyalkylene glycol (PAG; for example polyethylene glycol PEG), polyolefins, polyethylene terephthalates (PET), polyvinyl chlorides (PVC), polytetrafluoroethylene (PTFE), polyvinyl alcohols (PVA or PVOH, used here synonymously) and/or polyethylene oxide (for example with M_{W} at least about 70 000 to about 1 000 000). PVOH may also be used in various variants, for example with a hydrolysis level of 75 mol % to 98 mol %, and/or a 4% solution in water to DIN 53015, for example of 1 mPa*s to 60 mPa*s, and/or PVOH comprising further copolymerized monomers such as methyl methacrylate, methyl acrylate, 2-acrylamido-2-methylpropanesulfonic acid, maleic acid and/or itaconic acid; likewise and also, for example, PVOH copolymers having the Nichigo® G-Polymer brand name from Nippon Gohsei Group, and mixtures thereof. The carrier material onto which the aqueous polymer composition P1) is cast in accordance with the invention intrinsically also constitutes a layer and is therefore generally referred to here as “carrier material layer”.

The carrier material layer may, in the context of the present invention, also be further coated by agents or substances that facilitate later detachment of the polymer composition P1) cast thereon. Examples of these include agents and substances having an anti-adhesive effect, for example talc, surfactants, silicone-containing surfactants (including Zonyl-FSP), polymer foils (for example of polyolefin, polyethylene, polypropylene, polyvinyl chloride, polystyrene, silicone) and/or wax layers.

According to the invention, the aqueous polymer composition P1), after casting onto the carrier material or the carrier material layer, forms layer S1) as a constituent of the functional water-soluble to be produced in accordance with the invention.

In the context of the present invention, it is also possible that one or more suitable carrier material layers as described here do not become part of the foil to be produced in accordance with the invention, but serve, for example, for better removability of the cast foil from the carrier material. For example, polymer P1) may be cast onto a suitable carrier material as described here in order to form a layer S1), in order then (for example after the drying of S1)) to unroll layer S1) and optionally further layers S1) and/or S2) cast thereon, pulling them away from the carrier layer. Further examples and elucidations in this regard can be found in the figures and the examples. For instance, in the context of the present invention, those carrier materials that are insoluble or only sparingly soluble in water do not become part of the foil to be produced. These include, for example, (oriented) polypropylene (PP), polyethylene terephthalate, polyvinyl chloride (PVC), polystyrene, polytetrafluoroethylene, and others.

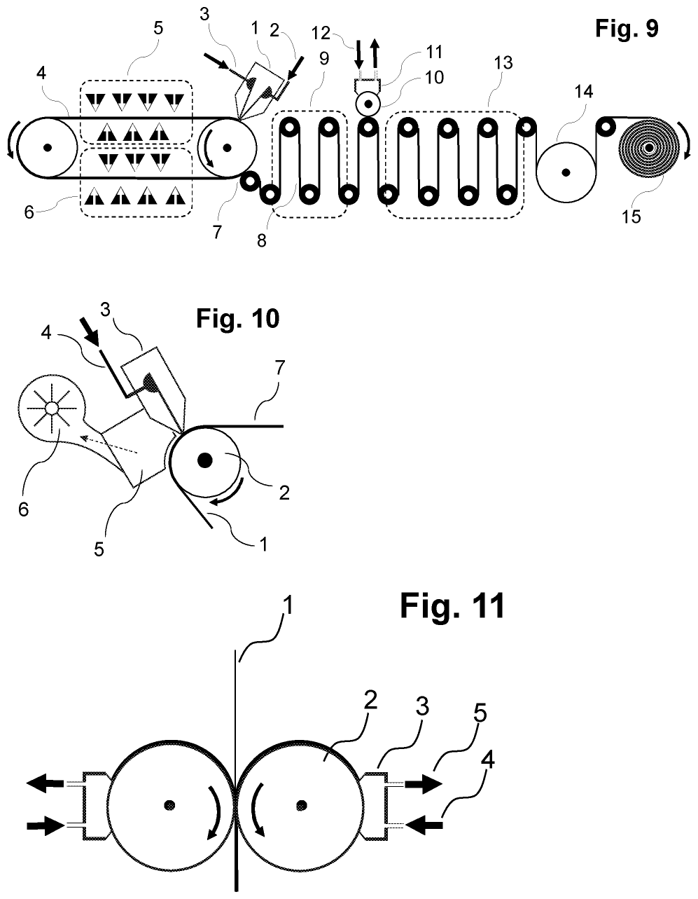

In the context of the present invention, it is also possible that one or more suitable carrier material layers as described herein also become part of the foil to be produced in accordance with the invention in that they are joined over a significant portion (at least about 50%, 55%, 60%, 65%, 70%, 75%, 80%, 85%, 90%, 95%, or 98%) of the area of layer S1) as described and detailed here. Joining is especially effected by adhesion forces between the individual layers, where coalescence of the individual layers should very substantially be avoided if the aim is functional separation of the layers on the basis of different functional constituents and/or different solubility (for example at different temperatures, pH values, etc.). Nevertheless, minor coalescence of the foils may be tolerated or desired, for example in order to further enhance the adhesion of the individual layers. The adhesion or tendency to adhesion (for example including coalescence) of the individual layers may be achieved or varied by the person skilled in the art by standard methods, for example by controlling the residual moisture content, viscosity, density and/or hydrophobicity of the layers. As further set out here, it is possible in the context of the present invention to cast layers of the foil to be produced either individually and successively (with or without intermediate drying; successive casting, for example, by means of a coating bar as also shown in the examples and in figures including 2, 13 and 14) or else simultaneously, for example by means of multislot dies or cascade casting or curtain coating or a combination of mono- and multilaminar casting (see, for example, FIGS. 8 and 9). Suitable carrier materials that are suitable in this context as a constituent of the foil to be produced in accordance with the invention especially comprise water-soluble substances, for example a layer S2) as further described here, nonwovens, or (especially water-soluble) polymers such as, inter alia, polyalkylene glycol (PAG; for example polyethylene glycol PEG) and/or polyvinyl alcohols (PVA and/or PVOH, used here synonymously) and/or polyethylene oxide (for example with M_{W} at least about 70 000 to about 1 000 000). PVOH may also be used in various variants, for example with a hydrolysis level of 75 mol % to 98 mol %, and/or a 4% solution in water to DIN 53015, for example of 1 mPa*s to 60 mPa*s, and/or PVOH consisting of further comonomers such as methyl methacrylate, methyl acrylate, 2-acrylamido-2-methylpropanesulfonic acid, maleic acid and/or itaconic acid; likewise and also, for example, PVOH copolymers having the Nichigo® G-Polymer brand name from Nippon Gohsei Group, and mixtures thereof. PVOH layers, for example, may serve for further mechanical stabilization of the water-soluble functional foil to be produced in accordance with the constitution and may therefore be part of the foil. Those carrier materials as detailed here and listed by way of example that are suitable as a constituent of the foil to be produced in accordance with the invention are also referred to herein generally as “includable carrier materials”. Such includable carrier materials may in principle also be applied as an interlayer or concluding layer as part of the foil to be used in accordance with the invention, for example in that they are applied (e.g. cast or laminated) onto a layer S1) or a further layer lying thereon as further set out here, either with a time delay or simultaneously with the underlying layer. One suitable concluding layer of the foil to be produced in accordance with the invention is especially PVOH as described here, since this can achieve elevated mechanical durability with low hygroscopicity. The casting of such polymer layers is known to those skilled in the art and is also described here above as part of the prior art.

A homogeneous thickness and/or surface of the interlayer or concluding layer of the foil to be produced in accordance with the invention can be achieved by measures known in the prior art, for instance by means of a doctor blade (for example BTG, Norcross Ga) or coating bars as described above, which are preferably each ceramic-coated.

Printing or embossing of the foil to be produced in accordance with the invention is also possible, for example by using gravure rolls or flexographic rolls with desired patterns, motifs or inscriptions, as described, for example, in U.S. Pat. Nos. 5,458,590 or 7,727,946. The foil to be used here in accordance with the invention is particularly suitable for the purpose, especially since it can, with multiple layers, achieve even a thickness that enables particularly deep and hence stable embossments. In the case of printing of the foil as described here, it is preferable to apply mechanically durable concluding layers to the foil of the invention, for example PVOH as described here more particularly as includable starting material.

The multilayer foil of the invention can, as stated, be printed finally or an intermediate step during the construction of the multilayer. This printing step may directly follow the foil production inline, in a separate printing or converting process or inline with the pod production. Suitable printing methods are inkjet printing, and also intaglio and surface printing such as flexographic printing, gravure printing or offset printing.

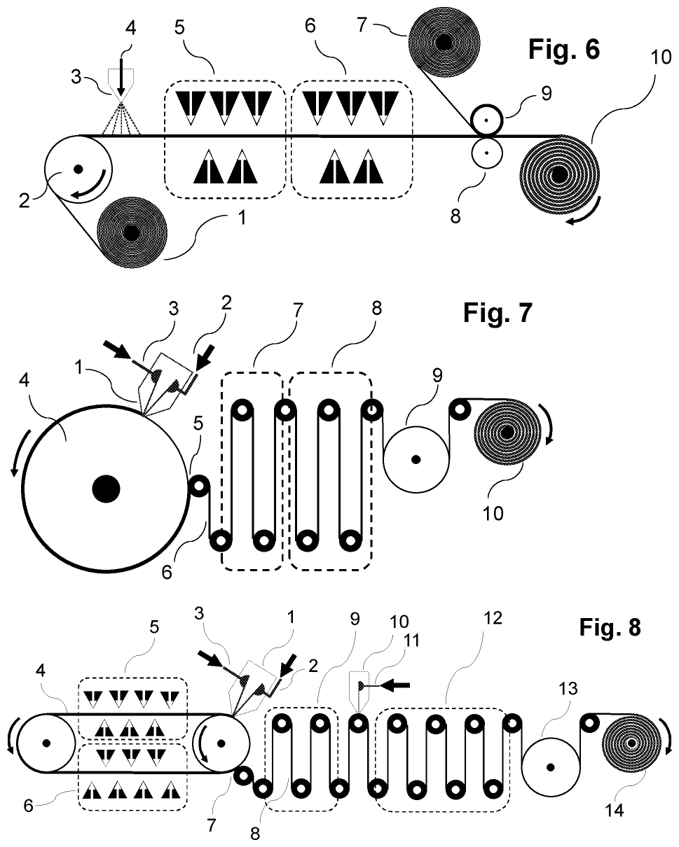

After the drying of the second layer S2) and prior to lamination step as detailed, for example, in the process variant according to FIG. 6, patterns or information can be printed on one of the interfaces that will be on the inside later on. Because the object printed on will be on an inner face, the object will be protected from outside influences, for example scratches, environmental humidity, contact with tacky surfaces or contact with other environmental influences. Suitable printing methods include intaglio and surface printing methods, for example flexographic printing, gravure printing, offset printing and inkjet printing.

A further option is the applying of an insert or label to one of the inner interfaces prior to laminating step. In this case, the insert is ensheathed in the laminating operation and fixed on the inner interface. One advantage of this method is dimensional stability in the later processing of the foil, for example on thermoforming in the production of unit-dose capsules, pouches, pods and the like. In this processing step, the printed image is distorted, which can impair the legibility, for example, of hazard messages.

According to the invention, the foil can also be produced by a lamination method. Laminating involves bonding two or more layers of the multilayer foil to one another over their area. If the foil is produced exclusively by lamination, all layers of the foil are bonded to one another over their area. The lamination can be effected successively (layer by layer), or laminates already consisting of two or more layers are bonded to one another. The foil can also be produced by a wet-on-wet application method. In addition, the foil can be produced using combinations of the aforementioned production methods.

After the applying of layer S1) to the carrier material, there may optionally be a drying step in which the residual moisture content of the polymer composition is reduced in order to accelerate foil formation and increase tear strength (mechanical stability). Such a drying operation can be effected by measures known to those skilled in the art. For example, the polymer composition may remain on the carrier material after casting until a desired drying level has been attained. For example, the polymer composition P1) may be cast onto a conveyor belt (either directly with the conveyor belt as carrier material, or indirectly onto a carrier material present directly or indirectly on the conveyor belt) which has a sufficient running length that the color composition has sufficient time to dry (for example by means of an air stream onto the surface to be dried) before it can be pulled off and, after optional further drying, rolled up (see, for example, FIG. 5). Other suitable drying methods include IR radiation (or other radiative drying techniques) and/or the rolling-up of the layer S1) formed by casting the polymer composition on a heated drum or a heating cylinder (see, for example, FIG. 7). According to the invention, the residual moisture allows either the applying and optionally bonding to one or more further layers or the rolling-up of the S1)-containing foil for further use. In one embodiment, the residual moisture content after the drying step is max. about 15% or 10%, based on the total mass of the layer. If the foil to be produced in accordance with the invention is separated from the carrier material, it may be subjected to further drying as an exposed foil by methods known to those skilled in the art (e.g. slot die or air circulation driers). The measurement of residual moisture content can be conducted via methods known to those skilled in the art, for example by gravimetry or via online determination of the water content to DIN EN ISO 15512 by, for example, NIR measurement, VIS/NIR measurement, microwave resonance measurement; or else off-line or by Karl Fischer titration, and calibration of the results from the test methods mentioned on the basis of DIN EN ISO 15512, preference being given to online methods.

As detailed here, it is optionally also possible to apply one or more further layers to layer S1), for example those as described here as layer S1) (or polymer composition P1)), as includable carrier materials or as layer S2 ((or polymer P2)), or else those as described here as carrier material layer which in that case need not necessarily remain part of the foil to be produced in accordance with the invention.

According to the invention, the optional applying of layer S2) is effected in a suitable manner as known to those skilled in the art (see above), for example also exactly as described above for the casting of the polymer composition P1) for formation of layer S1). It is also possible that a layer S2) is first applied to a suitable material as described here analogously for S1) as carrier material, in which case layer S2) itself serves as carrier material for layer S1). The invention as set out here allows a free choice of the sequence of the layers applied. However, the functional water-soluble foil to be produced in accordance with the invention, as described, comprises at least one layer S1).

As also after the applying of layer S1) to the carrier material, there may optionally be a drying step after the applying of layer S2) in which the residual moisture content of the polymer composition is reduced in order to accelerate film formation and increase tear strength (mechanical stability). Such a drying operation can be effected by measures known to those skilled in the art, for example by means of an air stream onto the surface to be dried. For example, the polymer composition may remain on the carrier material after casting until a desired drying level has been attained. For example, polymer P2) may be cast onto a conveyor belt (either directly with the conveyor belt as carrier material, or indirectly onto a carrier material (see FIG. 5, for example) present directly or indirectly on the conveyor belt) which has a sufficient running length that the color composition has sufficient time to dry before it can be pulled off and, after optional further drying, rolled up. Other suitable drying methods include IR radiation or other radiative drying techniques and/or the rolling-up of the layer formed by casting the polymer composition on a heated drum or a heating cylinder (see, for example, FIG. 7). According to the invention, the residual moisture allows either the applying to one or more further layers or the rolling-up of the S2)-containing foil for further use. In one embodiment, the residual moisture content after the drying step is max. about 15% or 10%, based on the total mass of the layer.

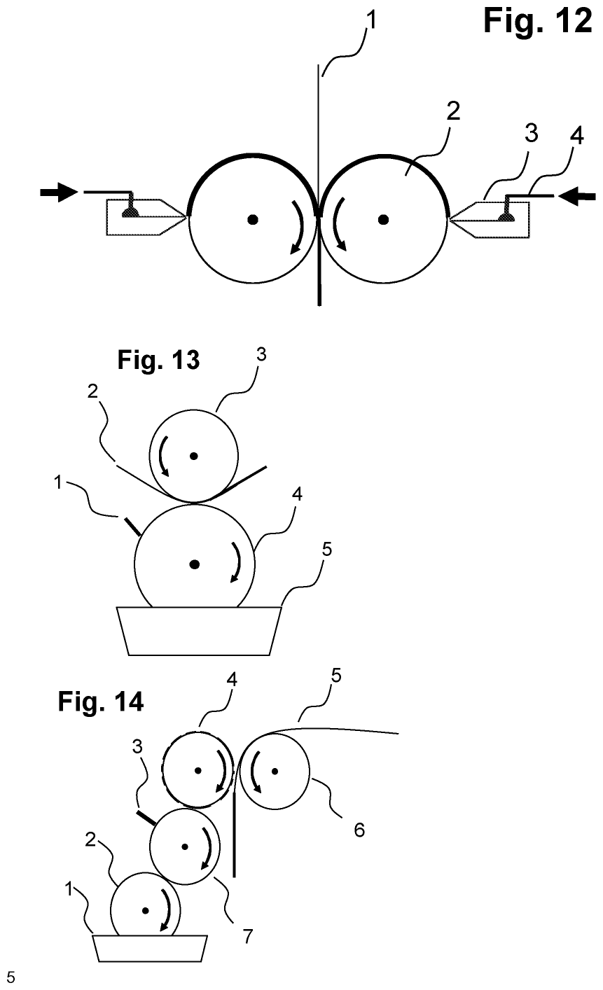

Subsequently, as required, one or more further layers may be applied, for example one or more layers S1), S2), and/or includable carrier materials, in each case optionally with a drying step between the applying of the layers. The layers may, as required, be applied in any sequence, simultaneously or successively, with or without an intermediate drying step, as described here for layers S1), S2) and. The simultaneous casting of multiple layers S1), S2), and/or includable carrier layers is also possible in principle, for example by means of multislot dies or cascade systems as described hereinabove. Double-sided coating is likewise possible (see, for example, FIGS. 11 and 12).

Once all layers encompassed by the functional water-soluble foil to be produced in accordance with the invention have been applied, the foil is dried as described (unless already done beforehand for the individual layers), preferably down to residual moisture content of max. about 15% or 10%, based on the total mass of the foil. This is intended, inter alia, to increase tear strength and enable rolling-up of the foil.

The functional water-soluble foil produced in accordance with the invention comprises at least one layer S1) as detailed here, but may also comprise multiple layers, for example one or more layers S1), S2), and/or includable carrier materials. In one embodiment of the present invention, the foil comprises at least 2 or 3 layers. In one embodiment of the present invention, the foil comprises at least one layer S1), one layer S2), and one further layer selected from the group consisting of S1, S2, and includable carrier materials.

The thickness of the simple layer S1) as detailed here may vary as required. For example, a thicker layer may naturally comprise more functional constituents and has higher mechanical stability. In one embodiment, layer S1) of the foil to be produced in accordance with the invention has a thickness of about 10 to 200 μm, preferably 20-80 μm, in each case measured after drying at a residual moisture content of max. about 15%, measured by the total mass of layer S1). Moreover, the thickness of the foil to be produced is small in relation to length and width in one embodiment. Preferably, the thickness of the foil is smaller by a factor of at least 10, more preferably of at least 20, particularly at least 50, especially at least 100, more especially at least 500, than the length of the greatest longitudinal axis. As also detailed here, it is likewise possible that multiple foil layers may also be layered one on top of another and optionally bonded, in order to achieve even thicker overall layers via multiple layers; for example when employed as shell or sheet, or pouch or pod. The printability of the foil to be produced in accordance with the invention as described here also improves with thickness.

The thickness of the foil to be produced in accordance with the invention is preferably below 3 mm, below 1 mm, below 500 μm, below 300 μm, below 200 μm, or below 100 μm. In the case of production of a foil comprising multiple layers with a multitude of functional constituents, including different functional constituents, the thickness of the entire foil to be produced in accordance with the invention may also be much higher, for example in the form of a shell or sheet, or pouch or pod, consisting predominantly of the foil to be produced in accordance with the invention.

The polymer composition P1) of the foil to be produced in accordance with the invention has advantageous properties. Without being bound to a theory, hydrogen bonds are able to form between the growing polymer and the polyether component, and these influence the properties of the resultant polymer composition. Thus, polymer compositions P1) having a high content of the polyether component can be attained; these cannot be prepared by mixing the separately prepared polymer with the polyether component. Free-radical polymer degradation advantageously does not take place here.

For production of the multilayer foils of the invention, preference is given to using polymer compositions P1) having a low glass transition temperature T_{G}. Preferably, the polymer compositions P1) used for production of the multilayer foils of the invention have a glass transition temperature T_{G} in the range from 0 to 80° C., preferably from 0 to 60° C., 0 to 45° C., especially 0 to 30° C.

The glass transition temperatures (Tg) described in the context of this invention can be determined by means of differential scanning calorimetry (DSC) and are common knowledge to the person skilled in the art.

The weight-average molecular weight M_{w} can be determined by means of methods that are common knowledge to the person skilled in the art, for example by means of GPC as known to the person skilled in the art and described here by way of example.

In a preferred embodiment, the polymer compositions P1) used for production of the washing- and cleaning-active polymer foils of the invention take the form of a transparent foil.

### Monomer A

As already described, polymer composition P1) is prepared by free-radical polymerization of monomer composition M1) in the presence of at least one polyether component PE), wherein the monomer composition M1) used comprises at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof.

In a specific embodiment, monomer composition M1) consists solely of α,β-ethylenically unsaturated carboxylic acids, salts of α,β-ethylenically unsaturated carboxylic acids and mixtures thereof.

The α,β-ethylenically unsaturated carboxylic acid is preferably selected from acrylic acid, methacrylic acid, ethacrylic acid, maleic acid, fumaric acid, itaconic acid, α-chloroacrylic acid, crotonic acid, citraconic acid, mesaconic acid, glutaconic acid and aconitic acid. Suitable salts of the aforementioned acids are especially the sodium, potassium and ammonium salts, and the salts with amines or amino alcohols. The monomers A) can be used as such or as mixtures with one another. The stated proportions by weight all refer to the acid form.

Preferably, the at least one α,β-ethylenically unsaturated carboxylic acid is used in non-neutralized form for polymerization. If the α,β-ethylenically unsaturated carboxylic acids are used for polymerization in partly neutralized form, the acid groups are neutralized preferably to an extent of at most 50 mol %, more preferably to an extent of at most 30 mol %.

More preferably, monomer A) is selected from acrylic acid, methacrylic acid, maleic acid, fumaric acid, itaconic acid, salts of the aforementioned carboxylic acids and mixtures thereof.

More particularly, monomer A) is selected from acrylic acid, methacrylic acid, salts of acrylic acid, salts of methacrylic acid and mixtures thereof.

In a specific embodiment, exclusively acrylic acid is used as monomer A).

Monomer A) is used preferably in an amount of 50% to 100% by weight, more preferably 60% to 100% by weight, based on the total weight of monomer composition M1).

In a preferred embodiment, monomer composition M1) consists to an extent of at least 50% by weight, preferably to an extent of at least 80% by weight and especially to an extent of at least 90% by weight, based on the total weight of monomer composition M1), of acrylic acid and/or acrylic acid salts.

### Monomer B)

Monomer composition M1) may, in addition to the monomers A), comprise at least one monomer B) selected from unsaturated sulfonic acids, salts of unsaturated sulfonic acids, unsaturated phosphonic acid, salts of unsaturated phosphonic acids and mixtures thereof.

Monomer B) is preferably selected from 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, vinylphosphonic acid, allylphosphonic acid, salts of the aforementioned acids and mixtures thereof.

A preferred monomer B) is 2-acrylamido-2-methylpropanesulfonic acid.

Suitable salts of the aforementioned acids are especially the sodium, potassium and ammonium salts, and the salts with amines. The monomers B) can be used as such or as mixtures with one another. The stated proportions by weight all refer to the acid form.

Preferably, monomer composition M1) in that case consists to an extent of at least 50% by weight, more preferably to an extent of at least 80% by weight and especially to an extent of at least 90% by weight, based on the total weight of monomer composition M1), of monomers A) and B). When monomer composition M1) comprises at least one monomer B), it is preferably used in an amount of 0.1% to 50% by weight, more preferably 1% to 25% by weight, based on the total weight of monomer composition M1).

### Monomers C)

Monomer composition M1) may additionally comprise at least one further monomer other than the monomers containing acid groups and salts thereof (=monomer C).

Monomer composition M1) may thus have the following monomer compositions: A) or A)+B) or A)+C) or A)+B)+C).

Preferably, monomer composition M1) additionally comprises at least one monomer C) selected from

C1) nitrogen heterocycles having a free-radically polymerizable α,β-ethylenically unsaturated double bond,
C2) compounds of the general formulae (I.a) and (I.b)

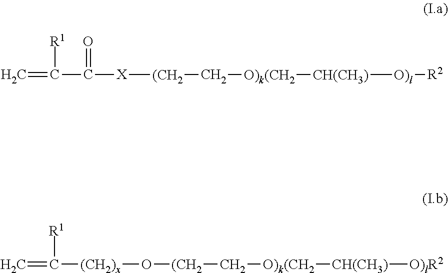

in which
the sequence of the alkylene oxide units is as desired,
x is 0, 1 or 2,
k and l are independently an integer from 0 to 100, where the sum of k and l is at least 2, preferably at least 5,
R¹ is hydrogen or C₁-C₈-alkyl,
R² is hydrogen, C₁-C₃₀-alkyl, C₂-C₃₀-alkenyl or C₅-C₈-cycloalkyl, and
X is O or a group of the formula NR³ in which R³ is H, alkyl, alkenyl, cycloalkyl, heterocycloalkyl, aryl or hetaryl;
C3) vinylaromatics,
C4) unsaturated hydrocarbons selected from C₂-C₁₀ monoolefins and nonaromatic hydrocarbons having at least two conjugated double bonds,
C5) esters of α,β-ethylenically unsaturated mono- and dicarboxylic acids with C₁-C₃₀-alkanols,
C6) compounds having one free-radically polymerizable α,β-ethylenically unsaturated double bond and at least one cationogenic and/or cationic group per molecule,
C7) esters of vinyl alcohol or allyl alcohol with C₁-C₃₀-monocarboxylic acids,
C8) esters of α,β-ethylenically unsaturated mono- and dicarboxylic acids with C₂-C₃₀-alkanediols, amides of α,β-ethylenically unsaturated mono- and dicarboxylic acids with C₂-C₃₀ amino alcohols having a primary or secondary amino group,
C9) monomers containing amide groups other than I.a), C6) and C8);
C10) α,β-ethylenically unsaturated nitriles,
C11) vinyl halides, vinylidene halides,
C12) ethylenically unsaturated monomers having urea groups,
and mixtures of two or more than two of the aforementioned monomers C1) to C12).

### Monomer C1)

Preferred nitrogen heterocycles with a free-radically polymerizable α,β-ethylenically unsaturated double bond C1) are selected from 1-vinylimidazole (N-vinylimidazole), vinyl- and allyl-substituted nitrogen heterocycles different from 1-vinylimidazole, and mixtures thereof.

The amine nitrogens of the aforementioned compounds can be used to produce charged cationic groups either by protonation with acids or by quaternization with alkylating agents. Suitable monomers C1) are also the compounds obtained by protonation or quaternization of 1-vinylimidazole and different vinyl- and allyl-substituted nitrogen heterocycles. Acids suitable for the protonation are, for example, carboxylic acids such as lactic acid or mineral acids such as phosphoric acid, sulfuric acid and hydrochloric acid. Alkylating agents suitable for quaternization are C₁-C₄-alkyl halides or di(C₁-C₄-alkyl) sulfates, such as ethyl chloride, ethyl bromide, methyl chloride, methyl bromide, dimethyl sulfate and diethyl sulfate. A protonation or quaternization may generally either precede or follow the polymerization. Preferably, a protonation or quaternization follows the polymerization. Examples of such charged monomers C1) are quaternized vinylimidazoles, in particular 3-methyl-1-vinylimidazolium chloride, methosulfate and ethosulfate.

Preferred monomers C1) are also vinyl- and allyl-substituted nitrogen heterocycles other than vinylimidazoles, selected from 2-vinylpyridine, 4-vinylpyridine, 2-allylpyridine, 4-allylpyridine, 2-vinylpiperidine, 4-vinylpiperidine and the salts thereof obtained by protonation or by quaternization.

More particularly, monomer composition M1) comprises at least one comonomer C1) selected from 1-vinylimidazole, 2-vinylpyridine, 4-vinylpyridine, 2-allylpyridine, 4-allylpyridine and the salts thereof obtained by protonation or by quaternization. Specifically, monomer composition M1) comprises 1-vinylimidazole as comonomer C1).

### Monomer C2)

Monomer composition M1) may additionally comprise at least one monomer C2) selected from compounds of the general formulae (I.a) and (I.b), as defined above.

In the formulae I.a) and I.b), k is preferably an integer from 1 to 500, more preferably 2 to 400, especially 3 to 250. Preferably, l is an integer from 0 to 100.

Preferably, R¹ in the formula I.a) is hydrogen, methyl, ethyl, n-propyl, isopropyl, n-butyl, sec-butyl, tert-butyl, n-pentyl or n-hexyl, especially hydrogen, methyl or ethyl.

Preferably, R² in the formulae I.a) and I.b) is n-octyl, 1,1,3,3-tetramethylbutyl, ethylhexyl, n-nonyl, n-decyl, n-undecyl, tridecyl, myristyl, pentadecyl, palmityl, heptadecyl, octadecyl, nonadecyl, arachyl, behenyl, lignoceryl, cerotyl, melissyl, palmitoleyl, oleyl, linoleyl, linolenyl, stearyl, lauryl.

Preferably, X in the formula I.a) is O or NH, especially O.

More preferably, monomer composition M1) comprises at least one monomer C2) selected from compounds of the general formulae (I.a1) and (I.b1)

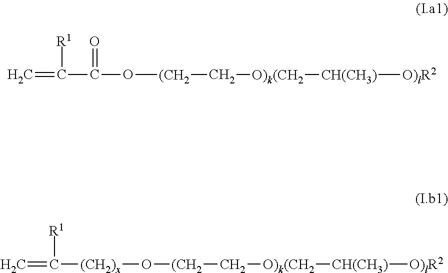

in which
the sequence of the alkylene oxide units is as desired,
x is 0, 1 or 2,
k and l are independently an integer from 0 to 100, where the sum of k and l is at least 2, preferably at least 5,
R¹ is hydrogen or methyl,
R² is hydrogen, C₁-C₄-alkyl.

In the formulae I.a1) and I.b1), k is preferably an integer from 1 to 100, more preferably 2 to 50, especially 3 to 30. Preferably, l is an integer from 0 to 50.

Preferably, R² in the formulae I.a1) and I.b1) is hydrogen, methyl, ethyl, n-propyl, isopropyl, n-butyl, sec-butyl or tert-butyl.

In the formula I.b1), x is preferably 1 or 2.

Suitable polyether acrylates I.a) or I.a1) are, for example, the polycondensation products of the aforementioned α,β-ethylenically unsaturated mono- and/or dicarboxylic acids and the acid chlorides, acid amides and acid anhydrides thereof with polyetherols. Suitable polyetherols can be prepared easily by reacting ethylene oxide, propylene 1,2-oxide and/or epichlorohydrin with a starter molecule such as water or a short-chain alcohol R²—OH. The alkylene oxides can be used individually, alternately in succession, or as a mixture. The polyether acrylates I.a1) can be used alone or in mixtures to prepare the polymers used in accordance with the invention.

Suitable allyl alcohol alkoxylates I.b) or I.b1) are, for example, the etherification products of allyl chloride with appropriate polyetherols. Suitable polyetherols can be prepared easily by reacting ethylene oxide, propylene 1,2-oxide and/or epichlorohydrin with a starter alcohol R²—OH. The alkylene oxides can be used individually, alternately in succession, or as a mixture. The allyl alcohol alkoxylates I.b) can be used alone or in mixtures to prepare the polymers used in accordance with the invention.

Monomers C2) used are especially methyl diglycol acrylate, methyl diglycol methacrylate, ethyl diglycol acrylate or ethyl diglycol methacrylate. Preference is given to ethyl diglycol acrylate.

Monomer C3)

Monomer composition M1) may additionally comprise at least one monomer C3) selected from vinylaromatics. Preferred vinylaromatics C3) are styrene, 2-methylstyrene, 4-methylstyrene, 2-(n-butyl)styrene, 4-(n-butyl)styrene, 4-(n-decyl)styrene and mixtures thereof. Particular preference is given to styrene and 2-methylstyrene, especially styrene.

Monomer C4)

Monomer composition M1) may additionally comprise at least one unsaturated hydrocarbon C4) selected from C₂-C₁₀ monoolefins and nonaromatic hydrocarbons having at least two conjugated double bonds.

Examples of C₂-C₁₀ monoolefins are ethene, propene, but-1-ene, but-2-ene, isobutene, pent-1-ene, pent-2-ene, 2-methyl-but-1-ene, 2-methyl-but-2-ene, 3-methyl-but-1-ene, 3-methyl-but-2-ene, 2,2-dimethylprop-1-ene, hex-1-ene, hex-2-ene, hex-3-ene, hept-1-ene, hept-2-ene, hept-3-ene, oct-1-ene, oct-2-ene, oct-3-ene, oct-4-ene, non-1-ene, non-2-ene, non-3-ene, non-4-ene, dec-1-ene, dec-2-ene, dec-3-ene, dec-4-ene, dec-5-ene and the positional isomers thereof, and also unsaturatedly terminated oligomers and polymers of the abovementioned olefins, especially of the α-olefins (ethene, propene, but-1-ene, pent-1-ene, hex-1-ene, hept-1-ene, oct-1-ene, non-1-ene, dec-1-ene).

Nonaromatic hydrocarbons having at least two conjugated double bonds refer to both aliphatic and cycloaliphatic unsaturated hydrocarbons having at least two conjugated double bonds. The cycloaliphatic unsaturated hydrocarbons having at least two conjugated double bonds are either those which do not comprise the maximum number of conjugated C—C double bonds defined by the ring size or those which do comprise the maximum number of conjugated C—C double bonds defined by the ring size but do not satisfy the Hückel rule, whether because the molecule is homoaromatic, antiaromatic or a nonaromatic polyene.

Aliphatic hydrocarbons having at least two conjugated double bonds generally comprise 4 to 20 carbon atoms. Examples of aliphatic hydrocarbons having at least two conjugated double bonds are 1,3-butadiene, 1,3-pentadiene, isoprene, 1,3-hexadiene, 2,4-hexadiene, 1,3,5-hexatriene, 1,3-heptadiene, 2,4-heptadiene, 1,3,4-heptatriene, 1,3-octadiene, 2,4-octadiene, 3,5-octadiene, 1,3,5-octatriene, 2,4,6-octatriene, 1,3,5,7-octatetraene and the like.

Cycloaliphatic hydrocarbons having at least two conjugated double bonds generally comprise 4 to 20 carbon atoms as ring members. Examples are 1,3-cyclopentadiene, 1,3-cyclohexadiene, 1,3-cycloheptadiene, 1,3,5-cycloheptatriene, 1,3-cyclooctadiene, 1,3,5-cyclooctatriene, 1,3,5,7-cyclooctatetraene and the like.

Preferred monomers C4) are ethene, propene, butene, isobutene, diisobutene, isoprene, 1,3-butadiene and mixtures thereof.

Monomer C5)

Monomer composition M1) may additionally comprise at least one monomer C5) selected from esters of α,β-ethylenically unsaturated mono- and dicarboxylic acids with C₁-C₃₀-alkanols.

Suitable esters of α,β-ethylenically unsaturated mono- and dicarboxylic acids with C₁-C₃₀-alkanols are, for example, methyl (meth)acrylate, methyl ethacrylate, ethyl (meth)acrylate, ethyl ethacrylate, n-propyl (meth)acrylate, isopropyl (meth)acrylate, n-butyl (meth)acrylate, tert-butyl (meth)acrylate, tert-butyl ethacrylate, n-pentyl (meth)acrylate, n-hexyl (meth)acrylate, n-heptyl (meth)acrylate, n-octyl (meth)acrylate,1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachyl (meth)acrylate, behenyl (meth)acrylate, lignoceryl (meth)acrylate, cerotyl (meth)acrylate, melissyl (meth)acrylate, palmitoleyl (meth)acrylate, oleyl (meth)acrylate, linoleyl (meth)acrylate, linolenyl (meth)acrylate, stearyl (meth)acrylate, lauryl (meth)acrylate and mixtures thereof.

Monomer C6)

Monomer composition M1) may additionally comprise at least one monomer C6) selected from compounds having a free-radically polymerizable α,β-ethylenically unsaturated double bond and at least one cationogenic and/or cationic group per molecule.

The cationogenic and/or cationic groups of the monomers C6) are preferably nitrogen-containing groups such as primary, secondary and tertiary amino groups, and quaternary ammonium groups. Preferably, the nitrogen-containing groups are tertiary amino groups or quaternary ammonium groups. Charged cationic groups can be produced from the amine nitrogens either by protonation or by quaternization with acids or alkylating agents. Examples of these include carboxylic acids such as lactic acid, or mineral acids such as phosphoric acid, sulfuric acid and hydrochloric acid, and examples of alkylating agents include C₁-C₄-alkyl halides or sulfates, such as ethyl chloride, ethyl bromide, methyl chloride, methyl bromide, dimethyl sulfate and diethyl sulfate. A protonation or quaternization may generally either precede or follow the polymerization.

Preferably, the monomers C6) are selected from esters of α,β-ethylenically unsaturated mono- and dicarboxylic acids with amino alcohols which may be mono- or dialkylated on the amine nitrogen, amides of α,β-ethylenically unsaturated mono- and dicarboxylic acids with diamines having at least one primary or secondary amino group, N,N-diallylamine, N,N-diallyl-N-alkylamines and derivatives thereof, and mixtures thereof.

The esters of α,β-ethylenically unsaturated mono- and dicarboxylic acids with amino alcohols which may be mono- or dialkylated on the amine nitrogen preferably derive from C₂-C₁₂ amino alcohols mono- or di-C₁-C₈-alkylated on the amine nitrogen. Suitable acid components of these esters are, for example, acrylic acid, methacrylic acid, fumaric acid, maleic acid, itaconic acid, crotonic acid, maleic anhydride, monobutyl maleate and mixtures thereof. The acid components used are preferably acrylic acid, methacrylic acid and mixtures thereof.

Preferred monomers C6) are N-methylaminoethyl (meth)acrylate, N-ethylaminoethyl (meth)acrylate, N-(n-propyl)aminoethyl (meth)acrylate, N-(tert-butyl)aminoethyl (meth)acrylate, N,N-dimethylaminomethyl (meth)acrylate, N,N-dimethylaminoethyl (meth)acrylate, N,N-diethylaminomethyl (meth)acrylate, N,N-diethylaminoethyl (meth)acrylate, N,N-dimethylaminopropyl (meth)acrylate, N,N-diethylaminopropyl (meth)acrylate and N,N-dimethylaminocyclohexyl (meth)acrylate.

Suitable monomers C6) are additionally the amides of the aforementioned α,β-ethylenically unsaturated mono- and dicarboxylic acids with diamines having at least one primary or secondary amino group. Preference is given to diamines having one tertiary amino group and one primary or secondary amino group.

Examples of preferred monomers C6) are N-[tert-butylaminoethyl](meth)acrylamide, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide and N-[4-(dimethylamino)cyclohexyl]methacrylamide.

Monomer C7)

Monomer composition M1) may additionally comprise at least one monomer C7) selected from compounds esters of vinyl alcohol or allyl alcohol with C₁-C₃₀ monocarboxylic acids.

Suitable esters of vinyl alcohol with C₁-C₃₀ monocarboxylic acids are, for example, methyl vinyl ester, ethyl vinyl ester, n-propyl vinyl ester, isopropyl vinyl ester, n-butyl vinyl ester, tert-butyl vinyl ester, n-pentyl vinyl ester, n-hexyl vinyl ester, n-heptyl vinyl ester, n-octyl vinyl ester, 1,1,3,3-tetramethylbutyl vinyl ester, ethylhexyl vinyl ester, n-nonyl vinyl ester, n-decyl vinyl ester, n-undecyl vinyl ester, tridecyl vinyl ester, myristyl vinyl ester, pentadecyl vinyl ester, palmityl vinyl ester, heptadecyl vinyl ester, octadecyl vinyl ester, nonadecyl vinyl ester, arachyl vinyl ester, behenyl vinyl ester, lignoceryl vinyl ester, cerotyl vinyl ester, melissyl vinyl ester, palmitoleyl vinyl ester, oleyl vinyl ester, linoleyl vinyl ester, linolenyl vinyl ester, stearyl vinyl ester, lauryl vinyl ester and mixtures thereof.

Monomer C8)

Monomer composition M1) may additionally comprise at least one monomer C8) selected from esters of α,β-ethylenically unsaturated mono- and dicarboxylic acids with C₂-C₃₀-alkanediols and amides of α,β-ethylenically unsaturated mono- and dicarboxylic acids with C₂-C₃₀ amino alcohols having a primary or secondary amino group.

Suitable esters of α,β-ethylenically unsaturated mono- and dicarboxylic acids with C₂-C₃₀-alkanediols are, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, etc.

Suitable amides of α,β-ethylenically unsaturated mono- and dicarboxylic acids with C₂-C₃₀ amino alcohols having a primary or secondary amino group are 2-hydroxyethylacrylamide, 2-hydroxyethylmethacrylamide, 2-hydroxyethylethacrylamide, 2-hydroxypropylacrylamide, 2-hydroxypropylmethacrylamide, 3-hydroxypropylacrylamide, 3-hydroxypropylmethacrylamide, 3-hydroxybutylacrylamide, 3-hydroxybutylmethacrylamide, 4-hydroxybutylacrylamide, 4-hydroxybutylmethacrylamide, 6-hydroxyhexylacrylamide, 6-hydroxyhexylmethacrylamide, 3-hydroxy-2-ethylhexylacrylamide and 3-hydroxy-2-ethylhexylmethacrylamide.

Monomer C9)

Monomer composition M1) may additionally comprise at least one monomer C9) selected from monomers containing amide groups other than I.a, C6) and C8).

Suitable monomers C9) containing amide groups are compounds of the general formula (V)

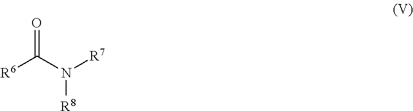

where
one of the R⁶ to R⁸ radicals is a group of the formula CH₂═CR⁹— where R⁹═H or C₁-C₄-alkyl and the other R⁶ to R⁸ radicals are each independently H, alkyl, cycloalkyl, heterocycloalkyl, aryl or hetaryl,
where R⁶ and R⁷, together with the amide group to which they are bonded, can also be a lactam having 5 to 8 ring atoms,
where R⁷ and R⁸, together with the nitrogen atom to which they are bonded, can also be a five- to seven-membered heterocycle.

Preferably, monomers C9) are selected from primary amides of α,β-ethylenically unsaturated monocarboxylic acids, N-vinylamides of saturated monocarboxylic acids, N-vinyllactams, N-alkyl- and N,N-dialkylam ides of α,β-ethylenically unsaturated monocarboxylic acids and mixtures thereof.

Preferred monomers C9) are N-vinyllactams and derivatives thereof which may have, for example, one or more C₁-C₆-alkyl substituents such as methyl, ethyl, n-propyl, isopropyl, n-butyl, sec-butyl, tert-butyl, etc. These include, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, etc.

Particular preference is given to using N-vinylpyrrolidone and/or N-vinylcaprolactam.

Suitable monomers C9) are also acrylamide and methacrylamide.

Suitable N-alkyl- and N,N-dialkylamides of α,β-ethylenically unsaturated monocarboxylic acids are, for example, methyl(meth)acrylamide, methylethacrylamide, ethyl(meth)acrylamide, ethylethacrylamide, n-propyl(meth)acrylamide, isopropyl(meth)acrylamide, n-butyl(meth)acrylamide, tert-butyl(meth)acrylamide, tert-butylethacrylamide, n-pentyl(meth)acrylamide, n-hexyl(meth)acrylamide, n-heptyl(meth)acrylamide, n-octyl(meth)acrylamide,1,1,3,3-tetramethylbutyl(meth)acrylamide, ethylhexyl(meth)acrylamide, n-nonyl(meth)acrylamide, n-decyl(meth)acrylamide, n-undecyl(meth)acrylamide, tridecyl(meth)acrylamide, myristyl(meth)acrylamide, pentadecyl(meth)acrylamide, palmityl(meth)acrylamide, heptadecyl(meth)acrylamide, nonadecyl(meth)acrylamide, arachyl(meth)acrylamide, behenyl(meth)acrylamide, lignoceryl(meth)acrylamide, cerotyl(meth)acrylamide, melissyl(meth)acrylamide, palmitoleyl(meth)acrylamide, oleyl(meth)acrylamide, linolyl(meth)acrylamide, linolenyl(meth)acrylamide, stearyl(meth)acrylamide, lauryl(meth)acrylamide, N-methyl-N-(n-octyl)(meth)acrylamide, N,N-di(n-octyl)(meth)acrylamide and mixtures thereof.

Open-chain N-vinylamide compounds suitable as monomers C9) are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide, N-vinylbutyramide and mixtures thereof. Preference is given to using N-vinylformamide.

Monomer C10)

Monomer composition M1) may additionally comprise at least one monomer C10) selected from α,β-ethylenically unsaturated nitriles.

Suitable α,β-ethylenically unsaturated nitriles are acrylonitrile or methacrylonitrile.

Monomer C11)

Monomer composition M1) may additionally comprise at least one monomer C11) selected from vinyl halides and vinylidene halides.

Suitable vinyl halides and vinylidene halides are vinyl chloride, vinylidene chloride, vinyl fluoride, vinylidene fluoride and mixtures thereof.

Monomer C12)

Monomer composition M1) may additionally comprise at least one monomer C12) selected from ethylenically unsaturated monomers having urea groups.

Suitable monomers C12) having urea groups are N-vinylurea, N-allylurea or derivatives of imidazolidin-2-one. These include N-vinyl- and N-allylimidazolidin-2-one, N-vinyloxyethylimidazolidin-2-one, N-(2-(meth)acrylamidoethyl)imidazolidin-2-one, N-(2-(meth)acryloyloxyethyl)imidazolidin-2-one (i.e. 2-ureido(meth)acrylate), N-[2-((meth)acryloyloxyacetamido)ethyl]imidazolidin-2-one, etc.

In a particular embodiment, monomer composition M1) comprises acrylic acid and optionally at least one comonomer selected from α,β-ethylenically unsaturated monocarboxylic acids (for example methacrylic acid) and dicarboxylic acids other than acrylic acid, salts, anhydrides, esters and amides of such α,β-ethylenically unsaturated mono- and dicarboxylic acids other than acrylic acid, olefinically unsaturated sulfonic acids (for example 2-acrylamido-2-methylpropanesulfonic acid AMPS), salts of olefinically unsaturated sulfonic acids, C₂-C₁₀ monoolefins, nonaromatic hydrocarbons having at least two conjugated double bonds, vinylaromatics, N-vinyllactams and mixtures thereof.

In a specific embodiment, monomer composition M1) comprises acrylic acid and optionally at least one comonomer selected from ethene, propene, isobutene, diisobutene, isoprene, 1,3-butadiene, methacrylic acid, 2-acrylamido-2-methylpropanesulfonic acid, maleic acid, maleic anhydride, itaconic acid, N-vinylpyrrolidone, N-vinylcaprolactam, N-vinylimidazole, styrene and mixtures thereof.

In a very specific embodiment, monomer composition M1) comprises acrylic acid and optionally at least one comonomer selected from methacrylic acid, 2-acrylamido-2-methylpropanesulfonic acid mixtures thereof.

More particularly, monomer composition M1) consists to an extent of at least 80% by weight, preferably to an extent of at least 90% by weight and especially to an extent of at least 95% by weight, based on the total weight of monomer composition M1), of acrylic acid.

Monomer composition M1) may comprise each of the further monomers C1) to C12) preferably in an amount of 0% to 30% by weight, more preferably 0% to 20% by weight and especially 0% to 10% by weight, based on the total weight of the monomer composition M1). When monomer composition M1) comprises at least one monomer selected from C1) to C12), it does so in each case preferably in an amount of 0.1% to 30% by weight, more preferably 1% to 20% by weight and especially 1.5% to 10% by weight, based on the total weight of monomer composition M1).

In a specific embodiment, monomer composition M1) does not comprise any further comonomers except for the monomers A) and B).

Even more specifically, the monomer composition does not comprise any further comonomers apart from acrylic acid.

The polymer composition P1) comprises essentially uncrosslinked polymers. The monomer composition M1) used for production of the polymer composition of the invention thus especially does not comprise any added crosslinking monomers. In the context of the invention, crosslinking monomers are compounds having two or more than two polymerizable ethylenically unsaturated double bonds per molecule.

Preferably, monomer composition M1), based on the total weight, comprises less than 0.1% by weight, more preferably less than 0.05% by weight and especially less than 0.001% by weight of crosslinking monomers having two or more than two free-radically polymerizable α,β-ethylenically unsaturated double bonds per molecule.

In a specific embodiment, monomer composition M1) does not comprise any crosslinking monomers having two or more than two polymerizable α,β-ethylenically unsaturated double bonds per molecule.

Polyether Component PE)

Suitable polyether components PE) are polyetherols having a number-average molecular weight of at least 200 g/mol and the mono- and di(C₁-C₆-alkyl ethers) thereof.

Suitable polyetherols and the mono- and di(C₁-C₆-alkyl ethers) thereof may be linear or branched, preferably linear. Suitable polyetherols and the mono- and di(C₁-C₆-alkyl ethers) thereof generally have a number-average molecular weight in the range from about 200 to 100 000, preferably 300 to 50 000, more preferably 500 to 40 000. Suitable polyetherols are, for example, water-soluble or water-dispersible nonionic polymers having repeat alkylene oxide units. Preferably, the proportion of repeat alkylene oxide units is at least 30% by weight, based on the total weight of the compound. Suitable polyetherols are polyalkylene glycols, such as polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2- and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in randomly distributed form or in the form of blocks. Preferably, the proportion of repeat units derived from ethylene oxide in the ethylene oxide/propylene oxide copolymers is 40% to 99% by weight. Particularly preferred polyether components PE) are ethylene oxide homopolymers and ethylene oxide/propylene oxide copolymers.

Suitable polyether components PE) are additionally the mono- and di(C₁-C₂-alkyl ethers) of the above-described polyetherols. Preference is given to polyalkylene glycol monomethyl ethers and polyalkylene glycol dimethyl ethers.

Suitable polyether components PE) are additionally surfactants containing polyether groups. In general, nonionic and ionic surfactants having at least one nonpolar group and at least one polar group and comprising a polyether group are suitable.

The surfactants PE) containing polyether groups are preferably selected from alkyl polyoxyalkylene ethers, aryl polyoxyalkylene ethers, alkylaryl polyoxyalkylene ethers, alkoxylated animal and/or vegetable fats and/or oils, fatty amine alkoxylates, fatty acid amide alkoxylates, fatty acid diethanolamide alkoxylates, polyoxyethylene sorbitan fatty acid esters, alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates, polyoxyalkylene sorbitan fatty acid esters and mixtures thereof.

The preferred nonionic surfactants PE) containing polyether groups include, for example:
alkyl polyoxyalkylene ethers which derive from low molecular weight C₃-C₆ alcohols or from C₇-C₃₀ fatty alcohols. The ether component here may be derived from ethylene oxide units, propylene oxide units, 1,2-butylene oxide units, 1,4-butylene oxide units and random copolymers and block copolymers thereof. Suitable nonionic surfactants comprise, inter alia, surfactants of the general formula (VI)

R¹⁰—O—(CH₂CH₂O)ₓ—(CHR¹¹CH₂O)_{y}—R¹² (VI)

in which R¹⁰ is a linear or branched alkyl radical having 6 to 22 carbon atoms,
R¹¹ and R¹² are each independently hydrogen or a linear or branched alkyl radical having 1 to
10 carbon atoms or H, where R¹² is preferably methyl, and
x and y are each independently 0 to 300. Preferably, x=1 to 100 and y=0 to 30.

These especially also include fatty alcohol alkoxylates and oxo alcohol alkoxylates, such as isotridecyl alcohol polyoxyethylene ethers and oleyl alcohol polyoxyethylene ethers.
surfactants containing hydroxyl groups of the general formula (VII)

R¹³—O—(CH₂CH₂O)ₛ—(CH₂CH₂CH₂O)ₜ—(CH₂CH₂CH₂CH₂O)ᵤ—(CH₂CHR¹⁴O)ᵥ—CH₂CH(OH)R¹⁵ (VII)

where
the sequence of the alkylene oxide units in the compounds of the formula (VII) is as desired,
s, t, u and v are independently an integer from 0 to 500, where the sum of s, t, u and v is >0,
R¹³ and R¹⁵ are independently a straight-chain or branched saturated C₁-C₄₀-alkyl radical or a mono- or polyunsaturated C₂-C₄₀-alkenyl radical, and
R¹⁴ is selected from methyl, ethyl, n-propyl, isopropyl and n-butyl.

In the compounds of the general formula (VII), the sum of s, t, u and v is preferably a value of 10 to 300, more preferably of 15 to 200 and especially of 20 to 150.

Preferably, t and u are each 0. In that case, the sum of s and v is preferably a value of 10 to 300, more preferably of 15 to 200 and especially of 20 to 150.

In the compounds of the general formula (VII), R¹³ and R¹⁵ are preferably independently a straight-chain or branched saturated C₂-C₃₀-alkyl radical. At the same time, R¹³ and R¹⁵ may also be mixtures of different alkyl radicals.

In the compounds of the general formula (VII), R¹⁴ is preferably methyl or ethyl, especially methyl.

A preferred embodiment is surfactants containing hydroxyl groups of the general formula (VII.1)

R¹³—O—(CH₂CH₂O)ₛ—(CH₂CH(CH₃)O)ᵥ—CH₂CH(OH)R¹⁵ (VII.1)

where
the sequence of the —(CH₂CH₂O)— and the (CH₂CH(CH₃)O)— units is as desired,
s and v are each independently an integer from 0 to 500, where the sum of s and v is >0, and
R¹³ and R¹⁵ are independently a straight-chain saturated C₁-C₃₀-alkyl radical or a branched saturated C₃-C₃₀-alkyl radical or a mono- or polyunsaturated C₂-C₃₀-alkenyl radical.

In the compounds of the general formula (VII.1), the sum of s and v is preferably a value of 10 to 300, more preferably of 15 to 200 and especially of 20 to 150.

The group of these nonionic surfactants includes, for example, hydroxy mixed ethers of the general formula (C₆₋₂₂-alkyl)-CH(OH)CH₂O-(EO)₂₀₋₁₂₀—(C₂₋₂₆-alkyl).
alcohol polyoxyalkylene esters of the general formula (VIII)

R¹⁶—O—(CH₂CH₂O)ₚ—(CH₂CHR¹⁷O)_{q}—C(═O)R¹⁸ (VIII)

where
the sequence of the alkylene oxide units in the compounds of the formula (VIII) is as desired,
p and q are independently an integer from 0 to 500, where the sum of p and q is >0,
R¹⁶ and R¹⁸ are independently a straight-chain or branched saturated C₁-C₄₀-alkyl radical or a mono- or polyunsaturated C₂-C₄₀-alkenyl radical, and
R¹⁷ is selected from methyl, ethyl, n-propyl, isopropyl and n-butyl.

In the compounds of the general formula (VIII), the sum of p and q is preferably a value of 10 to 300, more preferably of 15 to 200 and especially of 20 to 150.

In the compounds of the general formula (VIII), R¹⁶ and R¹⁸ are preferably each independently a straight-chain or branched saturated C₄-C₃₀-alkyl radical. At the same time, R¹⁶ and R¹⁸ may also be mixtures of different alkyl radicals.

In the compounds of the general formula (VIII), R¹⁷ is preferably methyl or ethyl, especially methyl.

These include, for example, lauryl alcohol polyoxyethylene acetate.
alkylaryl alcohol polyoxyethylene ethers, e.g. octylphenol polyoxyethylene ethers,
alkoxylated animal and/or vegetable fats and/or oils, for example corn oil ethoxylates, castor oil ethoxylates, tallow fat ethoxylates,
alkylphenol alkoxylates, for example ethoxylated isooctyl-, octyl- or nonylphenol, tributylphenol polyoxyethylene ether,
fatty amine alkoxylates, fatty acid amide and fatty acid diethanolamide alkoxylates, especially ethoxylates thereof,
polyoxyalkylene sorbitan fatty acid esters.

One example of an alkyl polyether sulfate is sodium dodecyl poly(oxyethylene) sulfate (sodium lauryl ether sulfate, SLES). A preferred commercially available modified fatty alcohol polyglycol ether is a polyethylene oxide CₓH₂ₓ₊₁/C_{y}H_{2y+1}-terminated at either end and having a free OH group and x, y=6-14.

As already detailed, the foil to be produced in accordance with the invention optionally or preferably comprises at least one further layer S2) comprising the at least one polymer P2) or consisting of at least one polymer P2) selected from
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid, especially copolymers comprising at least one copolymerized acrylic monomer selected from acrylic acid, acrylic salts and mixtures thereof, and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
copolymers comprising at least one copolymerized maleic monomer selected from maleic acid, maleic anhydride, maleic salts and mixtures thereof and at least one copolymerized C₂-C₈ olefin,
homo- and copolymers of acrylamide and/or methacrylamide,
polyamino acids,
water-soluble or water-dispersible polyamides,
polyalkylene glycols, mono- or diethers of polyalkylene glycols, and
mixtures thereof.

The foil to be produced in accordance with the invention more preferably comprises at least one further layer comprising or consisting of at least one polymer P2) selected from
cellulose ethers and cellulose esters,
homo- and copolymers comprising repeat units which derive from vinyl alcohol, vinyl esters, alkoxylated vinyl alcohols or mixtures thereof,
polymers selected from polyvinylpyrrolidone homopolymers, polyvinylimidazole homopolymers, copolymers comprising copolymerized vinylpyrrolidone and vinylimidazole, polyvinylpyridine N-oxide, poly-N-carboxymethyl-4-vinylpyridium halides,
mixtures thereof.

The foil to be produced in accordance with the invention especially comprises at least one further layer comprising or consisting of at least one polymer P2) selected from cellulose derivatives, preferably carboxyalkyl celluloses and salts thereof, sulfoalkyl celluloses and salts thereof, acidic sulfuric ester salts of cellulose, alkyl celluloses, hydroxyalkyl celluloses, hydroxyalkyl alkyl celluloses and mixtures of two or more of these cellulose derivatives.

Polysaccharides suitable as polymers P2) are natural polysaccharides, for example cellulose, hemicellulose, glycogen, starch (amylose and amylopectin), dextran, pectins, inulin, xanthan, chitin, callose, and thermally, hydrolytically or enzymatically degraded starch, e.g. maltodextrin etc.

Preferred modified polysaccharides are, for example, cellulose ethers, cellulose esters, cellulose amides, etc.

Cellulose ethers are derivatives of cellulose which arise through partial or complete substitution of the hydrogen atoms in the hydroxyl groups of the cellulose. Cellulose ethers from the reaction of cellulose with more than one etherifying agent are also referred to as cellulose mixed ethers.

Preferred cellulose ethers are selected from alkyl celluloses, hydroxyalkyl celluloses, hydroxyalkyl alkyl celluloses, carboxyalkyl celluloses and salts thereof, carboxyalkyl alkyl celluloses and salts thereof, carboxyalkyl hydroxyalkyl celluloses and salts thereof, carboxyalkyl hydroxyalkyl alkyl celluloses and salts, sulfoalkyl celluloses and salts thereof.

Preferred carboxyalkyl radicals are the carboxymethyl radical and the carboxyethyl radical. A particularly preferred carboxyalkyl radical is the carboxymethyl radical. Preferred sulfoalkyl radicals are the sulfomethyl radical and the sulfoethyl radical. A particularly preferred sulfoalkyl radical is the sulfomethyl radical. Preferred salts are the sodium, potassium, calcium and ammonium salts.

Particularly preferred cellulose ethers are selected from carboxymethyl cellulose, carboxyethyl cellulose, methyl cellulose, ethyl cellulose, n-propyl cellulose, ethyl methyl cellulose, hydroxyethyl cellulose, hydroxypropyl cellulose, hydroxybutyl cellulose, hydroxyethyl methyl cellulose, hydroxypropyl methyl cellulose, hydroxyethyl ethyl cellulose, hydroxypropyl ethyl cellulose, carboxymethyl methyl cellulose, carboxymethyl ethyl cellulose, carboxymethyl hydroxyethyl cellulose, carboxymethyl hydroxyethyl methyl cellulose, carboxymethyl hydroxyethyl ethyl cellulose, sulfomethyl cellulose and sulfoethyl cellulose. The carboxyalkyl radicals and the sulfoalkyl radicals may also be in salt form.

Cellulose esters are derivatives of cellulose which form as a result of esterification of the hydroxyl groups with acids. Preference is given to the sulfuric esters of cellulose. In a specific embodiment, the sulfuric acid is subjected only to a partial esterification, such that the resulting sulfuric esters still have free acid groups or salts thereof. Particular preference is given to using acidic sulfuric ester salts of cellulose. These are notable for their graying-inhibiting effect.

Preferred modified polysaccharides are selected from methyl cellulose, ethyl cellulose, propyl cellulose, methyl/ethyl cellulose, ethyl/propyl cellulose, carboxymethyl cellulose, salts of carboxymethyl cellulose, hydroxyethyl cellulose, hydroxypropyl cellulose, hydroxyethyl methyl cellulose, hydroxyethyl ethyl cellulose, hydroxypropyl methyl cellulose, hydroxypropyl ethyl cellulose, etc.

In a further preferred embodiment, the polymers P2) are selected from homo- and copolymers comprising repeat units which derive from vinyl alcohol, vinyl esters, alkoxylated vinyl alcohols or mixtures thereof.

Suitable vinyl esters (vinyl acylates) are generally the esters of vinyl alcohol with C₁-C₁₅ carboxylic acids, preferably C₁₋₈ carboxylic acids, more preferably C₁-C₄ carboxylic acids. Preferred vinyl acylates are vinyl acetate, vinyl n-propionate, vinyl n-butyrate, vinyl 2-ethylhexanoate, vinyl laurate, etc. Particular preference is given to vinyl acetate.

Partly or fully hydrolyzed polyvinyl acetates (PVAs) are generally referred to as “polyvinyl alcohol (PVOH or PVA)”. Partly hydrolyzed polyvinyl acetates are obtained by incomplete hydrolysis of polyvinyl acetates, meaning that the partly hydrolyzed polymer has both ester groups and hydroxyl groups. The hydrolysis of the polyvinyl acetates can be effected in a manner known per se under alkaline or acidic conditions, i.e. with addition of acid or base.

The performance properties of polyvinyl alcohols are determined by factors including the polymerization level and the hydrolysis level (level of hydrolysis). With rising hydrolysis level, the water solubility decreases. Polyvinyl alcohols having hydrolysis levels up to about 90 mol % are generally soluble in cold water. Polyvinyl alcohols having hydrolysis levels of about 90 to about 99.9 mol % are generally no longer soluble in cold water but are soluble in hot water.

Polyvinyl alcohols suitable as polymers P2) preferably have a hydrolysis level of 50 to 99.9 mol %, more preferably of 70 to 99 mol %, especially of 80 to 98 mol %.

Polyvinyl alcohols suitable as polymers P2) preferably have a weight-average molecular weight of 10 000 to 300 000 g/mol, more preferably of 15 000 to 250 000 g/mol.

Polyvinyl alcohols suitable as polymers P2) preferably point a viscosity of 2 to 120 mPa s, more preferably of 7 to 70 mPa s and especially of 15 to 60 mPa s, measured to DIN 53015 on a 4% solution in water.

In a further preferred embodiment, polymers P2) are selected from homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof.

N-Vinylimidazole, 2-vinylpyridine and 4-vinylpyridine can be converted to the corresponding salts by protonation or quaternization. Suitable acids are, for example, mineral acids such as sulfuric acid, hydrochloric acid and phosphoric acid, and carboxylic acids. Alkylating agents suitable for quaternization are C₁-C₄-alkyl halides or C₁-C₄-alkyl sulfates, such as ethyl chloride, ethyl bromide, methyl chloride, methyl bromide, dimethyl sulfate and diethyl sulfate.

Preference is given to polyvinylpyrrolidone homopolymers and copolymers comprising copolymerized N-vinylpyrrolidone and another different copolymerized ethylenically unsaturated monomer. Suitable N-vinylpyrrolidone copolymers are quite generally uncharged, anionic, cationic and amphoteric polymers.

Particularly preferred N-vinylpyrrolidone copolymers are selected from

copolymers of N-vinylpyrrolidone and vinyl acetate,
copolymers of N-vinylpyrrolidone and vinyl propionate,
copolymers of N-vinylpyrrolidone, vinyl acetate and vinyl propionate,
copolymers of N-vinylpyrrolidone and vinyl acrylate,
copolymers of N-vinylpyrrolidone, ethyl methacrylate and methacrylic acid,
copolymers of N-vinylpyrrolidone and N-vinylimidazole and derivatives thereof obtained by protonation and/or quaternization,
copolymers of N-vinylpyrrolidone and dimethylaminoethyl methacrylate and the derivatives thereof obtained by protonation and/or quaternization,
copolymers of N-vinylpyrrolidone, N-vinylcaprolactam and N-vinylimidazole and the derivatives thereof obtained by protonation and/or quaternization.

In a further preferred embodiment, the polymers P2) are selected from homo- and copolymers of acrylic acid and/or methacrylic acid.

In a first specific embodiment of the homo- and copolymers of acrylic acid and/or methacrylic acid, the polymer P2) used is an acrylic acid homopolymer. Acrylic acid homopolymers P2) preferably have a number-average molecular weight in the range from 800 to 70 000 g/mol, more preferably 900 to 50 000 g/mol, particularly 1000 to 20 000 g/mol and especially 1000 to 10 000 g/mol. In this context, the term “acrylic acid homopolymer” also encompasses polymers in which the carboxylic acid groups are in partly or fully neutralized form. These include acrylic acid homopolymers in which the carboxylic acid groups are present partly or completely in the form of alkali metal salts or ammonium salts. Preference is given to acrylic acid homopolymers in which the carboxylic acid groups are protonated or are partly or completely in the form of sodium salts. Homopolymers of acrylic acid particularly suitable as polymers P2) are the Sokalan® PA brands from BASF SE.

In a second specific embodiment of the homo- and copolymers of acrylic acid and/or methacrylic acid, polymer P2) used is a copolymer comprising at least one copolymerized acrylic acid monomer selected from acrylic acid, acrylic salts and mixtures thereof and at least one copolymerized maleic monomer selected from maleic acid, maleic anhydride, maleic salts and mixtures thereof. These preferably have a number-average molecular weight in the range from 2500 to 150 000 g/mol, more preferably 2800 to 70 000 g/mol, particularly 2900 to 50 000 g/mol and especially 3000 to 30 000 g/mol. Also included here are copolymers in which the carboxylic acid groups are in partly or fully neutralized form. For this purpose, it is either possible to use monomers in salt form for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

Preferred polymers P2) are copolymers of maleic acid (or maleic monomers) and acrylic acid (or acrylic monomers) in a weight ratio of 10:90 to 95:5, more preferably those in a weight ratio of 30:70 to 90:10.

Preferred polymers P2) are also terpolymers of maleic acid (or maleic monomers), acrylic acid (or acrylic monomers) and a vinyl ester of a C₁-C₃ carboxylic acid in a weight ratio of 10 (maleic acid):90 (acrylic acid+vinyl ester) to 95 (maleic acid):10 (acrylic acid+vinyl ester). The weight ratio of acrylic acid to vinyl ester is preferably within a range from 30:70 to 70:30.

Particularly suitable polymers P2) based on acrylic monomers and maleic monomers are the corresponding Sokalan® CP brands from BASF SE.

In a third specific embodiment of the homo- and copolymers of acrylic acid and/or methacrylic acid, polymer P2) used is a copolymer comprising at least one (meth)acrylic acid monomer selected from (meth)acrylic acid, (meth)acrylic salts and mixtures thereof and at least one hydrophobic monomer. The hydrophobic monomer is especially selected from C₁-C₈-alkyl esters of (meth)acrylic acid, for example the methyl, ethyl, n- and isopropyl, n-butyl and 2-ethylhexyl esters of (meth)acrylic acid and C₂-C₁₀ olefins, for example ethene, propene, 1,2-butene, isobutene, diisobutene, styrene and α-methylstyrene.

In a further preferred embodiment, the polymer P2) used is a copolymer of at least one maleic monomer selected from maleic acid, maleic anhydride, maleic salts and mixtures thereof with at least one C₂-C₈ olefin. Also suitable are copolymers comprising at least one copolymerized maleic monomer selected from maleic acid, maleic anhydride, maleic salts and mixtures thereof, at least one copolymerized C₂-C₈ olefin and at least one other different copolymerized comonomer.

Particular preference is given to copolymers comprising at least one copolymerized maleic monomer selected from maleic acid, maleic anhydride, maleic salts and mixtures thereof and at least one copolymerized C₂-C₈ olefin as the sole monomers. These preferably have a number-average molecular weight in the range from 3000 to 150 000 g/mol, more preferably 5000 to 70 000 g/mol, particularly 8000 to 50 000 g/mol and especially 10000 to 30 000 g/mol. Also included here are copolymers in which the carboxylic acid groups are in partly or fully neutralized form. For this purpose, it is either possible to use maleic salts for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

A specific embodiment is copolymers of maleic acid with C₂-C₈ olefins in a molar ratio of 40:60 to 80:20, particular preference being given to copolymers of maleic acid with ethylene, propylene, isobutene, diisobutene or styrene. Particularly suitable compounds which contain carboxylic acid groups and are based on olefins and maleic acid are likewise the corresponding Sokalan® CP brands from BASF SE.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized acrylic monomer selected from acrylic acid, acrylic salts and mixtures thereof.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized ester of (meth)acrylic acid. In that case, the ester of (meth)acrylic acid is especially selected from C₁-C₈-alkyl esters of (meth)acrylic acid, for example the methyl, ethyl, n- and isopropyl, n-butyl and 2-ethylhexyl esters of (meth)acrylic acid.

In a further preferred embodiment, the polymers P2) are selected from homo- and copolymers comprising at least one copolymerized monomer selected from acrylamide, methacrylamide and mixtures thereof. These polymers P2) are preferably water-soluble or water-dispersible. These polymers P2) are especially water-soluble.

In a specific embodiment, the polymers P2) are selected from homopolymers of acrylamide or methacrylamide.

In a further specific embodiment, the polymers P2) are selected from copolymers of acrylamide and/or methacrylamide. These comprise at least one copolymerized comonomer selected from hydrophilic monomers (A1) other than acrylamide and methacrylamide, monoethylenically unsaturated amphiphilic monomers (A2) and further ethylenically unsaturated monomers (A3).

Suitable hydrophilic monoethylenically unsaturated monomers (A1) are uncharged monomers such as N-methyl(meth)acrylamide, N,N′-dimethyl(meth)acrylamide or N-methylol(meth)acrylamide, monomers comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether, polyethylene glycol (meth)acrylate, N-vinylformamide, N-vinylacetamide, N-vinylpyrrolidone or N-vinylcaprolactam, and vinyl esters, for example vinyl formate or vinyl acetate. After polymerization, N-vinyl derivatives may be hydrolyzed to vinylamine units, and vinyl esters to vinyl alcohol units. Suitable hydrophilic monoethylenically unsaturated monomers (A1) are also monomers comprising at least one acidic group or salts thereof. These include acrylic acid, methacrylic acid, crotonic acid, itaconic acid, maleic acid, fumaric acid, vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, 2-acrylamido-2,4,4-trimethylpentanesulfonic acid, vinylphosphonic acid, allylphosphonic acid, N-(meth)acrylamidoalkylphosphonic acids, (meth)acryloyloxyalkylphosphonic acids and salts and mixtures thereof. The further monoethylenically unsaturated hydrophilic monomers may be hydrophilic cationic monomers. Suitable cationic monomers (A1c) especially include monomers having ammonium groups, especially ammonium derivatives of N-(ω-aminoalkyl)(meth)acrylamides or ω-aminoalkyl (meth)acrylates.

The amphiphilic monomers (A2) are monoethylenically unsaturated monomers having at least one hydrophilic group and at least one, preferably terminal, hydrophobic group.

The monomers (A3) may, for example, be monoethylenically unsaturated monomers that are more hydrophobic in character than the hydrophilic monomers (A1) and are accordingly water-soluble only to a minor degree. Examples of such monomers include N-alkyl- and N,N′-dialkyl(meth)acrylamides, where the number of carbon atoms in the alkyl radicals together is at least 3, preferably at least 4. Examples of such monomers include N-butyl(meth)acrylamide, N-cyclohexyl(meth)acrylamide or N-benzyl(meth)acrylamide.

In a further preferred embodiment, the polymers P2) are selected from polyamino acids. Suitable polyamino acids are in principle compounds comprising at least one copolymerized amino acid such as aspartic acid, glutamic acid, lysine, glycine, etc. The polyamino acids also include the derivatives obtainable by polymer-analogous reaction, such as esterification, amidation, etc. Preferred polyamino acids are polyaspartic acid, polyaspartic acid derivatives, polyglutamic acid, polyglutamic acid derivatives and mixtures thereof.

Polyaspartic acid can be prepared, for example, by alkaline hydrolysis of polysuccinimide (PSI, anhydropolyaspartic acid). Polysuccinimide can be prepared by thermal condensation of aspartic acid or from ammonia and maleic acid. Polyaspartic acid can be used, for example, as a biodegradable complexing agent and cobuilder in washing and cleaning compositions.

Polyamino acids having surfactant properties can be obtained by at least partly converting the free carboxylic acid groups of polyaspartic acid or polyglutamic acid to N-alkylamides and/or to esters. Polyaspartamides can also be prepared by reaction of polysuccinimide with amines. For preparation of hydroxylethylaspartamides, the ring opening of polysuccinimide can be conducted with ethanolamine. DE 37 00 128 A and EP 0 458 079 A describe the subsequent esterification of such hydroxyethyl derivatives with carboxylic acid derivatives. Copolymeric polyaspartic esters are obtainable as described in DE 195 45 678 A by condensation of monoalkyl esters of maleic or fumaric acid with addition of ammonia. DE 195 45 678 A further states that copolymeric polyaspartic esters are obtainable by reaction of polysuccinimide with alcohols, optionally followed by hydrolysis. According to the esterification level and hydrophobicity of the alcohol component, polyaspartic esters, aside from their biodegradability, are notable for excellent properties as stabilizers for O/W and W/O emulsions, as a foam-stabilizing and foam-boosting cosurfactant in washing and cleaning compositions, and as a complexing agent for metal cations.

In a further preferred embodiment, the polymers P2) are selected from polyalkylene glycols and mono- or diethers of polyalkylene glycols. Preferred polyalkylene glycols have a number-average molecular weight in the range from 1000 to 4 000 000 g/mol, more preferably from 1500 to 1 000 000 g/mol.

Suitable polyalkylene glycols and the mono- and diethers thereof may be linear or branched, preferably linear. Suitable polyalkylene glycols are, for example, water-soluble or water-dispersible nonionic polymers having repeat alkylene oxide units. Preferably, the proportion of repeat alkylene oxide units is at least 30% by weight, preferably at least 50% by weight and especially at least 75% by weight, based on the total weight of the compound. Suitable polyalkylene glycols are polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2- and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in randomly distributed form or in the form of blocks. Preferably, the proportion of repeat units derived from ethylene oxide in the ethylene oxide/propylene oxide copolymers is 40% to 99% by weight. Particular preference is given to ethylene oxide homopolymers and ethylene oxide/propylene oxide copolymers.

Suitable mono- and diethers of polyalkylene glycols are the mono(C₁-C₁₈-alkyl ethers) and di(C₁-C₁₈-alkyl ethers). Preferred mono- and diethers of polyalkylene glycols are the mono(C₁-C₆-alkyl ethers) and di(C₁-C₆-alkyl ethers). Especially preferred are the mono-(C₁-C₂-alkyl ethers) and di-(C₁-C₂-alkyl ethers). Especially preferred are polyalkylene glycol monomethyl ethers and polyalkylene glycol dimethyl ethers.

Polymer mixtures are suitable, for example, for adjusting the mechanical properties and/or the dissolution properties of the multilayer foils of the invention. The polymers used in the polymer mixture may differ in terms of their chemical composition and/or in terms of their physicochemical properties.

In a specific embodiment, the multilayer foil of the invention comprises at least one layer comprising a mixture of 2 or more polymers. Suitable mixtures may comprise 2 or more different polymer compositions P1) or at least one polymer composition P1) and at least one polymer P2) or 2 or more different polymers P2).

In a first embodiment, a polymer mixture comprising 2 or more polymers which differ in terms of their chemical composition is used. In a second embodiment, a polymer mixture comprising 2 or more polymers which differ in terms of their molecular weight is used. According to this second embodiment, for example, a polymer mixture comprising at least two polymers P2) comprising repeat units which derive from vinyl alcohol is used.

The foil to be produced in accordance with the invention have, as described, at least one layer S1) comprising or consisting of a polymer composition P1).

Preferably, the polymer composition P1) is produced by

A) providing a monomer composition M1) comprising at least one monomer A) selected from α,β-ethylenically unsaturated mono- and dicarboxylic acids, salts of α,β-ethylenically unsaturated mono- and dicarboxylic acids, anhydrides of α,β-ethylenically unsaturated mono- and dicarboxylic acids and mixtures thereof,
B) subjecting the monomer composition M1) provided in step A) to a free-radical polymerization in the presence of at least one polyether component PE) selected from polyetherols having a number-average molecular weight of at least 200 g/mol, mono- and di(C₁-C₆-alkyl) ethers thereof, surfactants containing polyether groups and mixtures thereof, optionally in the presence of at least one additive.

With regard to the monomer composition provided in step A), reference is made in full to the aforementioned suitable and preferred monomers A) and the optional comonomers B) and C).

The free-radical polymerization of monomer composition M1) in step B) is preferably conducted by the feed method. This may generally involve metering at least the monomers in liquid form into the reaction mixture. Monomers liquid under the metered addition conditions can be introduced into the reaction mixture without adding a solvent SL1), otherwise the monomers are used as solution in a suitable solvent SL1). It is also possible to use monomers that are in solid form.

The free-radical polymerization for production of the polymer composition P1) can be effected in the presence of a solvent SL1) selected from water, C₁-C₆-alkanols, polyols other than PE) and the mono- and dialkyl ethers and mixtures thereof. Suitable polyols and the mono- and dialkyl ethers thereof also include alkylene glycol mono(C₁-C₄-alkyl) ethers, alkylene glycol di(C₁-C₄-alkyl) ethers, oligoalkylene glycols and mono(C₁-C₄-alkyl) ethers and di(C₁-C₄-alkyl) ethers thereof.

The solvent SL1) is preferably selected from water, methanol, ethanol, n-propanol, isopropanol, n-butanol, ethylene glycol, ethylene glycol mono(C₁-C₄-alkyl) ethers, ethylene glycol di(C₁-C₄-alkyl) ethers, 1,2-propylene glycol, 1,2-propylene glycol mono(C₁-C₄-alkyl) ethers, 1,2-propylene glycol di(C₁-C₄-alkyl) ethers, glycerol, polyglycerols, oligoalkylene glycols having a number-average molecular weight of less than 1000 g/mol and mixtures thereof.

Suitable oligoethylene glycols are commercially available under the CTFA names PEG-6, PEG-8, PEG-12, PEG-6-32, PEG-20, PEG-150, PEG-200, PEG-400, PEG-7M, PEG-12M and PEG-115M. These specifically include the Pluriol E® brands from BASF SE. Suitable alkyl polyalkylene glycols are the corresponding Pluriol A . . . E® brands from BASF SE.

The solvent SL1) is more preferably selected from water, ethanol, n-propanol, isopropanol, ethylene glycol, diethylene glycol, triethylene glycol, 1,2-propylene glycol, 1,2-dipropylene glycol and mixtures thereof.

In a specific embodiment, the solvent SL1) used is selected from water and a mixture of water and at least one solvent SL1) other than water, selected from ethanol, n-propanol, isopropanol, ethylene glycol, diethylene glycol, triethylene glycol, 1,2-propylene glycol, 1,2-dipropylene glycol and mixtures thereof.

In a specific embodiment, the free-radical polymerization in step B) is effected in the presence of a solvent SL1) consisting to an extent of at least 50% by weight, preferably to an extent of at least 75% by weight and especially to an extent of at least 90% by weight, based on the total weight of the solvent SL1), of water. More particularly, the free-radical polymerization in step B) is effected in the presence of a solvent SL1) consisting entirely of water.

Preferably, the free-radical polymerization in step B) is effected in feed mode, in which case feeds comprising at least one α,β-ethylenically unsaturated carboxylic acid do not comprise any solvent SL1).

The metering rates of the monomer feed(s) and any further feeds (initiator, chain transfer agent, etc.) are preferably selected such that the polymerization is maintained with the desired conversion rate. The addition of the individual feeds here may be continuous, periodical, with constant or changing metering rate, essentially simultaneous or at different times. Preferably, the addition of all the feeds to the reaction mixture is continuous.

Preferably, for the free-radical polymerization, the monomer composition M1) and the polyether component PE) are used in a weight ratio of 0.5:1 to 5:1, more preferably of 0.7:1 to 3:1.

If the polymer composition is produced using a solvent SL1), the weight ratio of the polyether component PE) to the component S1) is preferably in the range from 0.1:1 to 5:1, more preferably from 0.5:1 to 3:1.

Preferably, the free-radical polymerization in step B) is effected at a temperature in the range from 20 to 95° C., more preferably from 30 to 90° C., especially from 40 to 80° C.

The free-radical polymerization in step B) can take place in the presence of at least one additive. Suitable additives are, for example, corrosion inhibitors, defoamers, dyes, fragrances, thickeners, solubilizers, organic solvents, electrolytes, antimicrobial active ingredients, antioxidants, UV absorbers, antiyellowing agents, bitter substances (e.g. Bitrex®) and mixtures thereof.

Preferably, the free-radical polymerization in step B) of the process comprises

B1) providing an initial charge comprising at least a portion of the polyether component PE), optionally at least a portion of the chain transfer agent CTA) and, if the polymerization is effected in the presence of a solvent SL1), optionally at least a portion of SL1);
B2) adding monomer composition M1) in one or more feed(s) and adding a feed comprising the free-radical initiator FRI), dissolved in a portion of at least one polyether component PE) and/or of the solvent SL1), and optionally adding a feed comprising the amount of the chain transfer agent CTA) which is not used in the initial charge;
B3) optional postpolymerizing the reaction mixture obtained in step B2).

Typically, the initial charge is heated to the polymerization temperature before the feeds are added while stirring.

Preferably, the individual reactants are added simultaneously in separate feeds, the flow rates of the feeds generally being kept very substantially constant over the period of addition.

Preferably, the amount of polyether component PE) in the initial charge (step B1)) is 30% to 100% by weight, more preferably 65% to 100% by weight and especially 80% to 100% by weight, based on the total weight of the polyether component PE) used for polymerization.

Preferably, the content of solvent SL1) in the initial charge is not more than 70% by weight, based on the total weight of the feedstocks in the forerun. Preferably, the content of solvent in the forerun is not more than 40% by weight, especially not more than 35% by weight, based on the total weight of the feedstocks in the forerun. The amount of solvent generally changes only by a few percent by weight over the entire course of the process. Typically, solvents SL1) having a boiling point at standard pressure (1 bar) of below 240° C. are used.

In a specific variant, the initial charge does not comprise any solvent. This is added only in step B2) via at least one of the feeds. In a very specific variant, no solvent is included in the initial charge and no solvent is added over the entire course of the process.

In a further specific variant, the solvent is initially charged in its entirety.

In a further specific variant, the initial charge does not comprise any chain transfer agent. If a chain transfer agent is used, this is added only in step B2) via at least one of the feeds.

The addition of the feeds in step B2) takes place over a period which is advantageously selected such that the heat of reaction forming during the exothermic polymerization reaction can be dissipated without relatively great technical complexity, e.g. without the use of a reflux condenser. Typically, the feeds are added over a period of 1 to 10 hours. Preferably, the feeds are added over a period of 2 to 8 hours, more preferably over 2 to 6 hours.

In an alternative embodiment, the free-radical polymerization in step B) of the process is continuous. In that case, monomer composition M1), the polyether component PE), at least one initiator, optionally at least one chain transfer agent CTA) and optionally at least one solvent SL1) are added to the reactor in the form of one liquid stream or preferably at least two liquid streams. In general, the stream comprising the initiator generally does not comprise the chain transfer agent as well. If at least two liquid streams are used, these are typically mixed to obtain the reaction mixture. The polymerization can be effected in one stage or in two or more than two, i.e. in 2, 3, 4, 5 or more, stages. In a suitable embodiment, in the case of a multistage polymerization, at least one additional stream is mixed in between at least two of the polymerization stages. This may be a monomer-containing stream, initiator-containing stream, solvent-containing stream, chain transfer agent-containing stream, a mixture thereof and/or any other stream of matter.

During the free-radical polymerization, the optionally used solvent and/or any condensation products that form are generally not removed. In other words, during the polymerization, there is typically only very minor mass transfer with the surroundings, if any, within the scope of the technical options.

The polymerization can generally be effected at ambient pressure or reduced or elevated pressure. Preferably, the polymerization is conducted at ambient pressure.

The polymerization is generally effected at constant temperature, but it can also be varied during the polymerization if required. Preferably, the polymerization temperature is kept as constant as possible over the entire reaction period, i.e. steps B2) and B3). According to the feedstocks which are used in the process of the invention, the polymerization temperature varies typically within the range from 20 to 95° C. Preferably, the polymerization temperature varies within the range from 30 to 90° C. and especially within the range from 40 to 80° C. If the polymerization is not conducted under elevated pressure and at least one optional solvent S1) has been added to the reaction mixture, the solvent or solvent mixture determines the maximum reaction temperature by virtue of the corresponding boiling temperatures.

The polymerization can be effected in the absence or presence of an inert gas. Typically, the polymerization is conducted in the presence of an inert gas. Inert gas is generally understood to mean a gas which, under the given reaction conditions, does not enter into any reaction with the reactants involved in the reaction, reagents, solvents or the products which form.

If the polymerization is conducted in the presence of a solvent, it is selected from the solvents SL1) described above.

For preparation of the polymers, the monomers can be polymerized with the aid of free radical-forming initiators, also referred to hereinafter as free-radical initiators or initiators. Useful free-radical initiators for the free-radical polymerization are in principle all free-radical initiators which are essentially soluble in the reaction medium as exists at the time when they are added and have sufficient activity to initiate the polymerization at the given reaction temperatures. It is possible to introduce one individual free-radical initiator or a combination of at least two free-radical initiators into the process of the invention. In the latter case, the at least two free-radical initiators can be used in a mixture or preferably separately, simultaneously or successively, for example at different times in the course of the reaction.

Free-radical initiators which may be used for the free-radical polymerization are the peroxo and/or azo compounds customary for the purpose, for example hydrogen peroxide, alkali metal or ammonium peroxodisulfates (for example sodium peroxodisulfate), diacetyl peroxide, dibenzoyl peroxide, succinyl peroxide, di-tert-butyl peroxide, tert-butyl peroxybenzoate, tert-butyl peroxypivalate, tert-butyl peroxyneodecanoate, tert-butyl peroxy-2-ethylhexanoate, tert-butyl peroxymaleate, cumene hydroperoxide, diisopropyl peroxydicarbamate, bis(o-tolyl) peroxide, didecanoyl peroxide, dioctanoyl peroxide, tert-butyl peroctoate, dilauroyl peroxide, tert-butyl perisobutyrate, tert-butyl peracetate, di-tert-amyl peroxide, tert-butyl hydroperoxide, 2,2′-azobisisobutyronitrile, 2,2′-azobis(2-amidinopropane) dihydrochloride (=azobis(2-methylpropionamidine) dihydrochloride), azobis(2,4-dimethylvaleronitrile) or 2,2′-azobis(2-methylbutyronitrile).

Also suitable are initiator mixtures or redox initiator systems, such as, for example, ascorbic acid/iron(II) sulfate/sodium peroxodisulfate, tert-butyl hydroperoxide/sodium disulfite, tert-butyl hydroperoxide/sodium hydroxymethanesulfinate, H₂O₂/Cu^{I}.

In the process of the invention, the amount of initiator system (initiator) used varies within the range from 0.01 to 10 pphm, preferably within the range from 0.1 to 5 pphm, more preferably within the range from 0.2 to 2 pphm and especially within the range from 0.3 to 1.5 pphm (parts per hundred monomer=parts by weight per hundred parts by weight of monomer).

In the process of the invention, the free-radical initiator is generally provided in the form of a solution in a solvent comprising at least one of the aforementioned solvents SL1) and optionally additionally at least one polyether of polyether component PE).

The polymerization can be effected without using a chain transfer agent (polymerization chain transfer agent) or in the presence of at least one chain transfer agent. Chain transfer agents generally refer to compounds having high transfer constants which accelerate chain transfer reactions and hence bring about a reduction in the degree of polymerization of the resulting polymers. The chain transfer agents can be divided into mono-, bi- and polyfunctional chain transfer agents, according to the number of functional groups in the molecule that can lead to one or more chain transfer reactions. Suitable chain transfer agents are described in detail, for example, by K. C. Berger and G. Brandrup in J. Brandrup, E. H. Immergut, Polymer Handbook, 3rd edition, John Wiley & Sons, New York, 1989, pp. II/81-II/141.

Suitable chain transfer agents are, for example, aldehydes such as formaldehyde, acetaldehyde, propionaldehyde, n-butyraldehyde, isobutyraldehyde.

Further usable chain transfer agents are formic acid and salts or esters thereof, such as ammonium formate, 2,5-diphenyl-1-hexene, hydroxyammonium sulfate and hydroxyammonium phosphate.

Further suitable chain transfer agents are allyl compounds, for example allyl alcohol, functionalized allyl ethers, such as allyl ethoxylates, alkyl allyl ethers, or glycerol monoallyl ether.

Chain transfer agents used are preferably compounds comprising sulfur in bound form. Compounds of this kind are, for example, inorganic hydrogensulfites, disulfites and dithionites or organic sulfides, disulfides, polysulfides, sulfoxides and sulfones. These include di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide. Suitable chain transfer agents are also thiols (compounds which comprise sulfur in the form of SH groups, also referred to as mercaptans). Preferred chain transfer agents are mono-, bi- and polyfunctional mercaptans, mercaptoalcohols and/or mercaptocarboxylic acids. Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans such as n-butyl mercaptan, n-hexyl mercaptan or n-dodecyl mercaptan. Examples of bifunctional chain transfer agents which comprise two sulfur atoms in bonded form are bifunctional thiols, for example dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bisthioglycolate. Examples of polyfunctional chain transfer agents are compounds which comprise more than two sulfurs in bound form. Examples thereof are trifunctional and/or tetrafunctional mercaptans.

The chain transfer agent is more preferably selected from mercaptoethanol, mercaptoacetic acid, mercaptopropionic acid, ethylhexyl thioglycolate and sodium hydrogensulfite.

Preferred chain transfer agents are also hypophosphorous acid (phosphinic acid) and salts of hypophosphorous acid. A preferred salt of hypophosphorous acid is the sodium salt.

If a chain transfer agent is used in the process of the invention, the amount is typically 1 to 40 pphm (“parts per hundred monomer”, i.e. parts by weight based on one hundred parts by weight of monomer composition). Preferably, the amount of chain transfer agent used in the process of the invention is in the range from 3 to 30 pphm, particularly preferably in the range from 5 to 25 pphm. It is also possible to conduct the polymerization without adding a chain transfer agent.

Typically, the chain transfer agent is added continuously to the polymerization mixture in step B2) entirely via one of the feeds. However, it is also possible to add the chain transfer agent either entirely to the initial charge, i.e. before the actual polymerization, or only some of the chain transfer agent is included in the initial charge and the remainder is added continuously to the polymerization mixture in step B2) via one of the feeds. The chain transfer agent can be added here in each case without or with solvent SL1).

The amount of chain transfer agent and the way in which it is added to the reaction mixture have a major influence on the average molecular weight of the polymer composition. If no chain transfer agent or only a small amount of chain transfer agent is used and/or if the addition predominantly precedes the polymerization, this generally leads to higher average molecular weights of the polymer formed. If, by contrast, a relatively large amount of chain transfer agent is used and/or the addition of the chain transfer agent takes place for the most part during the polymerization (step B2)), this generally leads to a smaller average molecular weight.

Preferably, the polymer compositions obtained after the end of the polymerization (step B3)) is transferred to a suitable vessel and optionally cooled directly to ambient temperature (20° C.).

The polymer compositions P1) obtained in this way are advantageously suitable for production of multilayer foils, for example for use as a washing or cleaning composition or as a sheath for a liquid washing or cleaning composition. The production of multilayer foils and of sheaths based thereon is described in detail hereinafter.

The weight-average molecular weight M_{w} of the polymer composition P1) of the invention can be determined, for example, by means of gel permeation chromatography (GPC) in aqueous solution using neutralized polyacrylic acid as polymer standard, as is common knowledge to the person skilled in the art. This type of molecular weight determination covers the components of the polymer composition which comprise the monomers M1) in copolymerized form. The polymer composition P1) preferably has a weight-average molecular weight of 2000 to 100 000 g/mol, preferably of 3000 to 80 000 g/mol.

The polymer composition P1) has a sufficiently low glass transition temperature T_{G} suitable for foil formation. Preferably, the polymer compositions P1) have a glass transition temperature T_{G} in the range from 0 to 80° C., more preferably from 0 to 60° C., especially from 0 to 30° C.

Prior to use for foil production (i.e. before it passes through a drying operation), the polymer composition P1) preferably has a content of acid groups of more than 1 mmol/g, more preferably of more than 1.3 mmol/g. Prior to use for foil production, the polymer composition P1) preferably has a content of acid groups of not more than 15 mmol/g. Prior to use for foil production, the polymer composition P1) especially has a content of acid groups of 1.5 mmol/g to 10 mmol/g.

In a preferred embodiment, the acid groups of the polymer composition according to the invention are in non-neutralized form.

The present invention further relates to a functional water-soluble foil producible or produced by a process as detailed and described here.

As used here, the singular forms of “a” or “the” each also include the plural forms unless explicitly detailed otherwise.

The representation of “and/or” conjunctions as used here in each case includes both the individual meanings “and” and “or” and the meaning “all or any individual combination(s)” of the respective enumeration.

The expression “about” as used here should be understood synonymously with “roughly” or “approximately” and includes ranges of 20%, preferably 15%, 10% 75% 5%, 3%, 2%, or 1%, in each case above and below the value stated. The expression “about” likewise includes the exact value specified in each case.

The expression “including” or “comprising” (and forms thereof) includes both the option of the presence of further constituents or forms, but also in each case includes the form “consisting of” which excludes further constituents or forms.

The expression “producible by” includes all products producible by the process mentioned, irrespective of whether they have been produced directly by the process designated. The latter products are identified here by the expression “produced by”. But the expression “producible by” as used here also encompasses, as a restricted form, the narrower expression “produced by” and may be replaceable thereby.

The figures show:

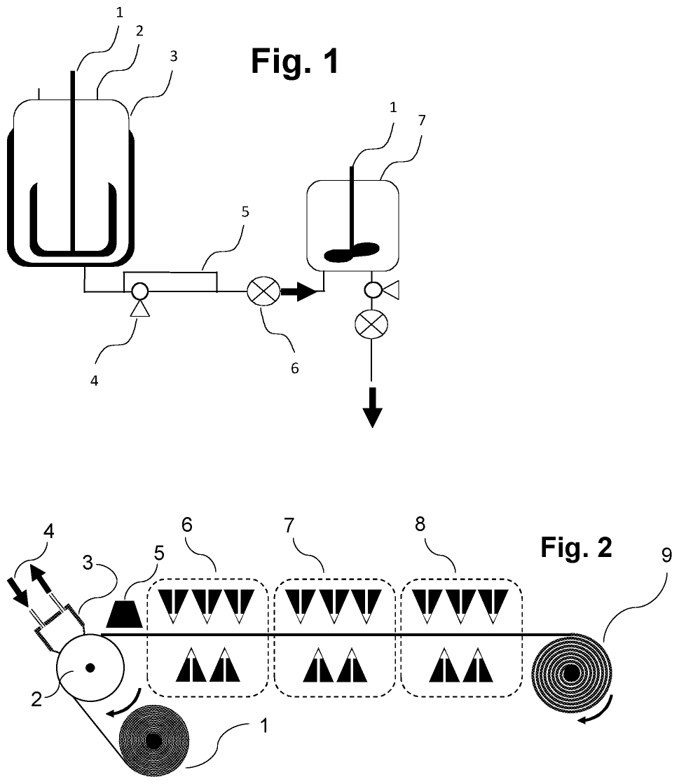

FIG. 1 1. stirrer unit; 2. inlet/outlet; 3. jacketed tank; 4. pump; 5. pump circulation; 6. filtration units; 7. tank

FIG. 2 1. unwinding with roll of the carrier material; 2. support roll; 3. box applicator; 4. liquid feed (feed); 5. online measurement of basis weight. 6./7./8. convective drier (different T and air flow); 9. winding of the coated carrier material

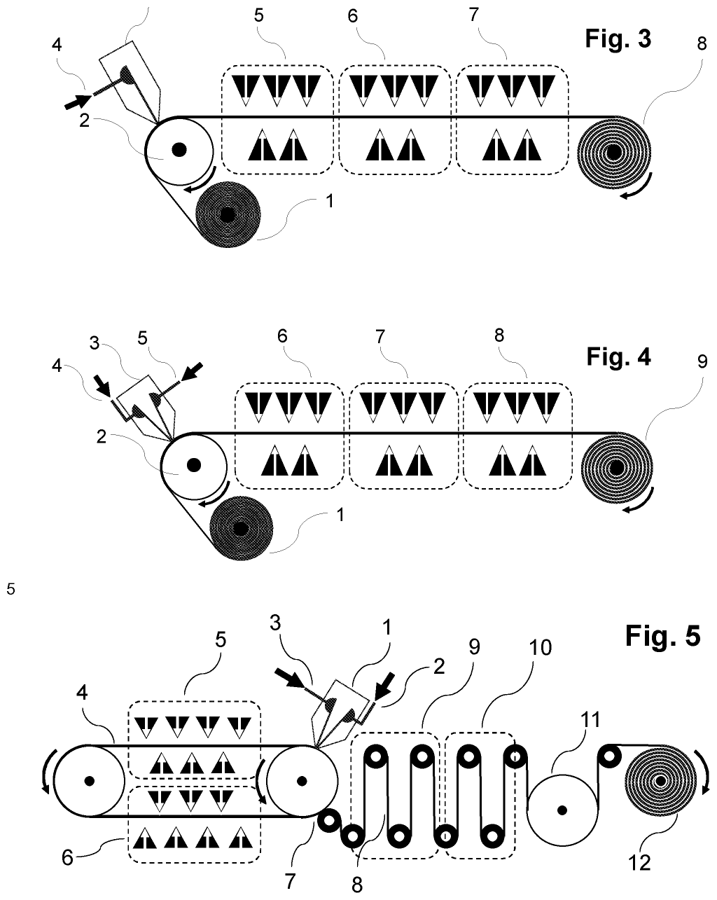

FIG. 3 1. unwinding with roll of the carrier material; 2. support roll; 3. slot die for applying the polymer composition; 4. liquid feed to the slot die (feed); 5./6./7. convective drier (different T and air flow); 8. winding of the coated carrier material

FIG. 4 1. unwinding with roll of the carrier material; 2. support roll; 3. dilaminar slot die for simultaneous application of two polymer compositions; 4. liquid feed to the slot die (bottom layer); 5. liquid feed to the slot die (top layer); 6./7./8. convective drier (different T and air flow); 9. winding of the coated carrier material

FIG. 5 1. dilaminar slot die for simultaneous application of two polymer compositions; 2. liquid feed to the slot die (bottom layer); 3. liquid feed to the slot die (top layer); 4. steel belt as carrier material (run over both rolls in circulation); 5./6. convective drying zones (different T and air flow); 7. removal of the dilaminar foil from the steel belt; 8. separate foil; 9./10. further drying of the separate dilaminar foil (different T and air flow); 11. chill roll (optional); 12. winding of the dilaminar foil

FIG. 6 1. unwinding with roll of the carrier material; 2. support roll; 3. spray nozzle; 4. liquid feed (feed); 5./6. convective drier (different T and air flow); 7. unwinding of lamination foil; 8. support roll; 9. contact roll; 10. winding of the joined foil composite (laminate)

FIG. 7 1. dilaminar slot die for simultaneous application of two polymer compositions; 2. liquid feed to the slot die (bottom layer); 3. liquid feed to the slot die (top layer); 4. heating cylinder; 5. removal of the dilaminar foil from the steel belt; 6. separate foil; 7./8. further drying of the separate dilaminar foil (different T and air flow); 9. chill roll (optional); 10. winding of the dilaminar foil

FIG. 8 1. dilaminar slot die for simultaneous application of two polymer compositions; 2. liquid feed to the slot die (bottom layer); 3. liquid feed to the slot die (top layer); 4. steel belt as carrier material (run over both rolls in circulation); 5./6. convective drying zones (different T and air flow); 7. removal of the dilaminar foil from the steel belt; 8. separate foil; 9./12. further drying of the separate dilaminar foil (different T and air flow); 10. slot die for application of a further lamina of polymer composition; 11. liquid feed to the slot die; 13. chill roll (optional); 14. winding of the dilaminar foil

FIG. 9 1. dilaminar slot die for simultaneous application of two polymer compositions; 2. liquid feed to the slot die (bottom layer); 3. liquid feed to the slot die (top layer); 4. steel belt as carrier material (run over both rolls in circulation); 5./6. convective drying zones (different T and air flow); 7. removal of the dilaminar foil from the steel belt; 8. separate foil; 9./13. further drying of the separate dilaminar foil (different T and air flow); 10. application roll for application of a further lamina of polymer composition; 11. chamber for polymer composition; 12. liquid feed (feed); 14. chill roll (optional); 15. winding of the dilaminar foil

FIG. 10 1. carrier material; 2. support roll; 3. slot die for applying the polymer composition (mono- or multilaminar); 4. liquid feed to the slot die (feed); 5. vacuum box; 6. reduced pressure-generating fan; 7. coated carrier material

FIG. 11 1. film/substrate; 2. application rolls; 3. chamber applicator; 4. coating solution duct/feed; 5. return flow to the reservoir vessel

FIG. 12 1. film/substrate; 2. application rolls; 3. slot dies; 4. coating solution duct/feed

FIG. 13 1. doctor blade; 2. film/substrate; 3. guide roll/contact roll; 4. application roll; 5. coating solution reservoir

FIG. 14 1. coating solution reservoir; 2. roll; 3. doctor blade; 4. application roll; 5. film/substrate; 6. support roll/contact roll; 7. roll

The present invention is elucidated and illustrated in detail by the examples which follow without being restricted to the embodiments and features detailed therein.

### EXAMPLES

Making Up the Solutions

Preparation of Polymer Composition P1-1)

TABLE 1

| | Feedstock | Amount (% by wt.) | Content (%) |
|---|---|---|---|
| Initial charge | C₁₃C₁₅ oxo alcohol | 24.40 | 100.00 |
| | with 7 EO | | |
| | Water^{a)} | 18.40 | 100.00 |
| Feed 1 | Acrylic acid | 48.80 | 100.00 |
| Feed 2 | Initiator^{b)} | 0.34 | 100.00 |
| | Water^{a)} | 3.89 | 100.00 |
| Feed 3 | 2-Mercaptoethanol | 0.49 | 100.00 |
| | Sodium hypophosphite | 1.33 | 55.00 |
| | Water^{a)} | 2.42 | 100.00 |

^{a)}demineralized water,
^{b)}2,2′-azobis(2-methylpropionamidine) dihydrochloride (CAS No. 2997-92-4)

The initial charge was heated to 75° C. while stirring at 100 rpm. Then feeds 1, 2 and 3 were metered in within 4 h and the reaction mixture was polymerized for a further hour. The mixture was then allowed to cool down to room temperature. The polymer composition is obtained in the form of a transparent and viscous solution. The weight-average molecular weight M_{w} of the polymer composition P1-6) obtained was 12 100 g/mol.

The weight-average molecular weight Mw of the polymer composition P1-1) obtained was determined by means of gel permeation chromatography (GPC) in aqueous solution using neutralized polyacrylic acid as polymer standard. In this type of molecular weight determination, the components of the polymer composition which comprise the aforementioned monomers M) in copolymerized form are ascertained.

Standard: neutralized polyacrylic acid. The calibration was carried out with narrow distribution Na-PAA standards from PSS (Polymer Standards Service GmbH) with molecular weights of M=1250 to M=1 100 000 g/mol. In addition, PAA standards from the American Polymer Standards Corporation with molecular weight M=1770 and M=900 g/mol were used. The values outside of this elution range were extrapolated.
Eluent: 0.01 mol/L phosphate buffer pH=7.4 in distilled water with 0.01 M NaN₃
Flow rate: 0.8 mL/min
Injection volume: 100 μL
Concentration: 1.5 mg/mL
The sample solutions were filtered through Millipore IC Millex-LG filter (0.2 μm).
Column name: TSKgel GMPWXL
Column attachment: 2 separation columns (length=each 30 cm), exclusion limit 1000-8 000 000 g/mol
Detector: DRI Agilent 1200 UV Agilent 1200 VWD [260 nm]

Production of an Application Solution A (for Foil Layers of Polyvinyl Alcohol)

18 g of a solid polyvinyl alcohol (Poval® 26-88 from Kuraray, nonvolatile components: 97.5%) were dissolved in 82 g of deionized water at 60° C. while stirring. 1.8 g of glycerol (>99.5%, Sigma Aldrich) and 0.18 g of a C₁₃C₁₅ oxo alcohol with 7 EO were added to 100 g of the polyvinyl alcohol solution thus prepared. The solution was heated to 80° C. Polyvinyl alcohol application solution A was mixed well and heated at 80° C. until the air stirred in had escaped completely.

Production of an application solution B (for foil layers of polymer composition P1-1) To 397.30 g of the above-described polymer composition P1-1) are added, while stirring at 80° C., firstly 29.00 g of glycerol (>99.5%, Sigma Aldrich) and lastly 26.80 g of deionized water. Application solution B was mixed well and heated at 80° C. until the air stirred in had escaped completely.

Production of an application solution C (for foil layers of carboxymethyl cellulose) 4 g of a sodium carboxymethyl cellulose (WALOCEL® CRT 2000 PA from Dow Wolff Cellulosics, solids content: 92%) were dissolved in 96 g of deionized water at 60° C. while stirring. 1 g of glycerol (>99.5%, Sigma Aldrich) was added to 100 g of the carboxymethyl cellulose solution thus prepared. The solution was heated to 80° C. The carboxymethyl cellulose application solution C was mixed well and heated at 80° C. until the air stirred in had escaped completely.

Production of an application solution D (for foil layers comprising a copolymer that acts as dye transfer inhibitor (DTI))

51.55 g of a copolymer of 1-vinylpyrrolidone and 1-vinylimidazole (Sokalan® HP 56 granules from BASF SE, solids content: 97%) were dissolved in 48.45 g of deionized water while stirring. 12.5 g of glycerol (>99.5%, Sigma Aldrich) were added to 100 g of the dye transfer inhibitor solution prepared. Subsequently, by addition of deionized water, the polymer concentration of the solution was adjusted to 35.0% by weight. Polymer application solution D was mixed well and heated at 80° C. until the air stirred in had escaped completely.

Aqueous solutions of layers S1-S2, if they are includable layers, are produced in stirred, heatable tanks (FIG. 1). These tanks consist of or are coated with corrosion-resistant materials. These include enameled tanks or those made of steels as described here above in general terms. The stirrers to be used should be designed such that they assure good mixing of the solution (e.g. Intermig, anchor stirrers, etc.), with minimization of the introduction of air into the solution, for example by complete immersion of the stirrer units into the solution or adjusted stirrer speed. To prepare the solution, water (generally deionized water) is initially charged and the appropriate polymer is added at room temperature while stirring. The mixture is then heated; this can be effected by adding direct steam or via jacket heating. When direct steam is used, the amount of water introduced by the steam is included in the overall mass balance. In addition, the polymers can also be mixed and/or dissolved with the water directly via speed-controlled mixers (dynamic mixers). The polymer solutions can be adjusted to processing temperature or regulated to this temperature later on in the process. Further admixtures such as plasticizers, fillers, active substances (enzymes, fragrances, etc.) can be initially charged together with the dilution water, or be added after the preparation of the solution or in the course of conveying of the solution. Feeds to further mixes and nozzles are designed either such that the temperature of the solution remains constant or such that it drops to a desired temperature. Some of these conduits have been designed such that the solution can be partly or entirely circulated, which means that it is possible to control the temperature of solutions and conduits in startup processes or in the event of interruptions or reduced throughput, and to prevent gel formation etc. In addition, there is at least one filter unit in said conduit zone, in which extraneous matter present and gel particles are removed. The filter unit is optionally back-flushable. The polymer solutions conveyed are optionally pumped prior to casting in a reservoir vessel, the inlet and outlet of which are in the base of the vessel. The inlet may optionally also be mounted at the side or the top of the vessel. There may optionally be a further stirrer unit in said reservoir vessel. The vessel should be configured such that the introduction of air into the solution is minimized. The incorporation of a reservoir vessel allows buffering of discontinuous solution production, and continuous casting of the film is assured. There is optionally a further filtration unit downstream of the reservoir vessel. Vessels and filters should be designed so as to minimize any temperature drop in the solution.

Foil Production

All layers formed from application solutions A to D here may additionally also comprise, inter alia, plasticizers as described here in general terms.

The foil layer composition corresponds to the composition of the multilayer foil after drying. The solutions applied are described in the general section “Making up the solution”.

Thickness measurement and determination of basis weight:

Film thicknesses were determined by means of a digital gauge (Mitutoyo Absolute Digimatic gauge, ID-H model) with a flat, circular stylus of diameter 5 mm. The thickness was measured over an average of at least 10 measurement positions per foil. The layer thickness variations are within a range of ±10%. Basis weight was determined gravimetrically over an area of 80 mm×80 mm.

### Example 1.1

Dilaminar Foil A-B: 1st Layer of Polyvinyl Alcohol, 2nd Layer of Polymer Composition P1-1)

For production of the multilayer foil, in a coating system from Mathis AG with a box applicator as applicator (FIG. 2). Application solution A (production as described above) is initially charged in the box applicator and applied at a belt speed of 0.5 m/min to a siliconized polyester foil (foil thickness 36 μm, Hostaphan® RN 2PRK) as carrier material. By means of contactless online layer thickness measurement based on ultrasound absorption (MeSys GmbH, USM-200), the doctor blade gap is varied until attainment of the desired basis weight of 10 g/m². Subsequently, the film is subjected to convective drying in a slot die drier. The temperatures of the 3 drier zones, each of length 1 m, are 100, 80 and 60° C. in sequence in coating direction. The wound roll is removed from the winder and mounted in the unwinder in order to coat the second lamina thereon. In this subsequent step, application solution B is initially charged in the box applicator and applied to the carrier material already coated with A at a belt speed of 1 m/min. By means of contactless online layer thickness measurement based on ultrasound absorption (MeSys GmbH, USM-200), the doctor blade gap is varied until attainment of the desired basis weight of 70 g/m². Subsequently, the film is subjected to convective drying in a slot die drier. The temperatures of the 3 drier zones, each of length 1 m, are 100, 80 and 60° C. in sequence in coating direction. The carrier material can remain part of the roll for storage or transport and serves as separator. Prior to further use of the dilaminar A-B coating as a separate water-soluble foil, the dilaminar foil has to be removed. This can be effected in a separate step (rewinding from the roll to a new bobbin) or in the processing step itself, for example in pouch production. The foil produced in this way has a basis weight of about 80 g/m² and comprises about 70 g/m² of B.

### Example 1.2

Dilaminar Foil A-B: 1st Layer of Polyvinyl Alcohol, 2nd Layer of Polymer Composition P1-1)

For production of the multilayer foil, a slot die from TSE Troller AG with width 150 mm is used in a coating system from Mathis AG (FIG. 3). The syringe initially charged with the free-flowing polymer composition, the liquid feed and the nozzle are at a controlled temperature of 40° C. Application solution A is applied by means of a syringe pump (Nexus 6000 from Chemyx) at 4.2 mL/min at a belt speed of 0.5 m/min to a siliconized polyester foil (foil thickness 36 μm, Hostaphan® RN 2PRK) as carrier material, and then subjected to convective drying in a slot die drier. The temperatures of the 3 drier zones, each of length 1 m, are 100, 80 and 60° C. in sequence in coating direction. The wound roll is removed from the winder and mounted in the unwinder in order to coat the second lamina thereon. In this subsequent step, application solution B is applied by means of a syringe pump (Nexus 6000 from Chemyx) at 16.2 mL/min at a belt speed of 1 m/min to the carrier material already coated with A, and then subjected to convective drying in a slot die drier. The temperatures of the 3 drier zones are 100, 80 and 60° C. in sequence in coating direction. The carrier material can remain part of the roll for storage or transport and serves as separator. Prior to further use of the dilaminar A-B coating as a separate water-soluble foil, the dilaminar foil has to be removed. This can be effected in a separate step (rewinding from the roll to a new bobbin) or in the processing step itself, for example in pouch production. The foil produced in this way has a basis weight of about 80 g/m² and comprises about 70 g/m² of B.

### Example 1.3

Dilaminar Foil A-B: 1st Layer of Polyvinyl Alcohol, 2nd Layer of Polymer Composition P1-1)

For production of the multilayer foil, a dilaminar slot die from TSE Troller AG with width 150 mm is used in a coating system from Mathis AG (FIG. 4). The two syringes initially charged with the free-flowing polymer compositions, the liquid feed and the nozzle are at a controlled temperature of 40° C. Application solution A is fed into the front slot in coating direction via a syringe pump (Nexus 6000 from Chemyx) at 4.2 mL/min. Application solution B is fed into the rear slot in coating direction via a syringe pump (Nexus 6000 from Chemyx) at 8.1 mL/min at a belt speed of 0.5 m/min. Thus, by parallel operation of the two pumps, both polymer compositions are applied simultaneously to the carrier material and then subjected to convective drying in a slot die drier. The temperatures of the 3 drier zones are 120, 110 and 60° C. in sequence in coating direction. The carrier material can remain part of the roll for storage or transport and serves as separator. Prior to further use of the dilaminar A-B coating as a separate water-soluble foil, the carrier foil has to be removed. This can be effected in a separate step (rewinding from the roll to a new bobbin) or in the processing step itself, for example in pouch production. The foil produced in this way has a basis weight of about 80 g/m² and comprises about 70 g/m² of B.

### Example 1.4

Dilaminar Foil A-B: 1st Layer of Polyvinyl Alcohol, 2nd Layer of Polymer Composition P1-1)

For production of the multilayer foil, a dilaminar slot die from TSE Troller AG with width 150 mm is used in a foil casting system with a continuous steel belt (CrNi steel, length 16 m) (FIG. 5). The two reservoir vessels initially charged with the free-flowing polymer compositions, the liquid feed and the nozzle are at a controlled temperature of 40° C. Application solution A is fed into the front slot in coating direction via a gear pump (P64627/71023201/1MA-A/6-19 from Gather) at 16.7 mL/min. Application solution B is fed into the rear slot in coating direction via a gear pump (P64627/71023201/1MA-A/6-19 from Gather) at 27.7 mL/min at a belt speed of 1 m/min. Thus, by parallel operation of the two pumps, both polymer compositions are applied simultaneously to the carrier material, in this case a CrNi steel belt, and then subjected to convective drying in a slot die drier. The temperatures, 150° C. in the upper part and 60° C. in the lower part, and the fan output in the drier zones are chosen such that the moisture content of water is <15% by weight when the foil is removed from the steel belt. After the separation of steel belt and foil, the foil is subsequently subjected in separate form to further drying in a convective drier at 60° C. Prior to the winding, the foil is cooled to room temperature by means of a chill roll and the surface is treated with talc as separating agent. The foil produced in this way has a basis weight of about 140 g/m² and comprises about 120 g/m² of B.

### Example 2.1

Trilaminar Foil A-B-A: 1st Layer of Polyvinyl Alcohol, 2nd Layer of Polymer Composition P1-1), 3rd Layer of Polyvinyl Alcohol

For production of a trilaminar multilayer foil, in a coating system from Mathis AG with a box applicator as applicator (FIG. 2). Analogously to example 1.2, a dilaminar A-B coating is produced on the carrier foil beforehand. Application solution A is then initially charged in the box applicator and applied to the already twice-coated carrier material at a belt speed of 1 m/min. By means of contactless online layer thickness measurement based on ultrasound absorption (MeSys GmbH, USM-200), the doctor blade gap is varied until attainment of the desired basis weight of 10 g/m². Subsequently, the trilaminar coating is subjected to convective drying in a slot die drier. The temperatures of the 3 drier zones, each of length 1 m, are 100, 80 and 60° C. in sequence in coating direction. The carrier material can remain part of the roll for storage or transport and serves as separator. Prior to further use of the trilaminar A-B-A coating as a separate water-soluble foil, the carrier foil has to be removed. This can be effected in a separate step (rewinding from the roll to a new bobbin) or in the processing step itself, for example in pouch production. The foil produced in this way has a basis weight of about 90 g/m² and comprises an average of about 70 g/m² of B.

### Example 2.2

Trilaminar Foil A-B-A: 1st Layer of Polyvinyl Alcohol, 2nd Layer of Polymer Composition P1-1), 3rd Layer of Polyvinyl Alcohol

For production of the trilaminar multilayer foil, a slot die from TSE Troller AG with width 150 mm is used in a coating system from Mathis AG (FIG. 3). Analogously to example 1.2, a dilaminar A-B coating is produced on the carrier foil. Subsequently, application solution A is applied again by means of a syringe pump (Nexus 6000 from Chemyx) at 8.3 mL/min at a belt speed of 1 m/min to the already twice-coated carrier material, and then subjected to convective drying in a slot die drier. Here too, the syringe initially charged with the free-flowing polymer composition, the liquid feed and the nozzle are at a controlled temperature of 40° C. The temperatures of the 3 drier zones, each of length 1 m, are 100, 80 and 60° C. in sequence in coating direction. The carrier material can remain part of the roll for storage or transport and serves as separator. Prior to further use of the trilaminar A-B-A coating as a separate water-soluble foil, the carrier foil has to be removed. This can be effected in a separate step (rewinding from the roll to a new bobbin) or in the processing step itself, for example in pouch production. The foil produced in this way has a basis weight of about 90 g/m² and comprises an average of about 70 g/m² of B.

### Example 2.3

Trilaminar Foil A-B-A: 1st Layer of Polyvinyl Alcohol, 2nd Layer of Polymer Composition P1-1), 3rd Layer of Polyvinyl Alcohol

For production of the trilaminar multilayer foil, analogously to example 1.2, a dilaminar A-B coating is produced on the carrier foil. Subsequently, a PVOH foil (polyvinyl alcohol foil, Monosol M8630 from Kuraray, 76 μm) is laminated (by means of thermal joining) or coated (by means of an adhesive) onto the dilaminar-coated carrier foil in a coating system from Kroenert (FIG. 6). For this purpose, at a belt speed of 5 m/min, the polymer composition surface is moistened with water by an ultrasound nozzle (WideTrack from SonoTek Corporation, nozzle frequency 48 kHz) at a pump rate of 18.0 mL/min (Nexus 6000 from Chemyx). In the coating module, under a pressure of 4 bar, the A foil and the moistened multilaminar-coated carrier foil are joined by a rubberized roll (Shore hardness 80). The carrier material can remain part of the roll for storage or transport and serves as separator. Prior to further use of the trilaminar A-B-A composite as a separate water-soluble foil, the carrier foil has to be removed. This can be effected in a separate step (rewinding from the roll to a new bobbin) or in the processing step itself, for example in pouch production. The foil produced in this way has a basis weight of about 156 g/m² and comprises an average of about 70 g/m² of B.

Tetralaminar Foil

### Example 3.1

Tetralaminar Foil C-B-D-A: 1st Layer of Carboxymethyl Cellulose, 2nd Layer of Polymer Composition P1-1), 3rd Layer of Dye Transfer Inhibitor, 4th Layer of Polyvinyl Alcohol

For production of the multilayer foil, in a coating system from Mathis AG with a box applicator as applicator (FIG. 2). Application solution C is initially charged in the box applicator and applied at a belt speed of 0.5 m/min to a siliconized polyester foil (foil thickness 36 μm, Hostaphan® RN 2PRK) as carrier material. By means of contactless online layer thickness measurement based on ultrasound absorption (MeSys GmbH, USM-200), the doctor blade gap is varied until attainment of the desired basis weight of 10 g/m². Subsequently, the film is subjected to convective drying in a slot die drier. The temperatures of the 3 drier zones, each of length 1 m, are 100, 80 and 60° C. in sequence in coating direction.

The wound roll is removed from the winder and mounted in the unwinder in order to coat the second lamina thereon. In this subsequent step, application solution B is initially charged in the box applicator and applied to the carrier material already coated with A at a belt speed of 1 m/min. By means of contactless online layer thickness measurement based on ultrasound absorption (MeSys GmbH, USM-200), the doctor blade gap is varied until attainment of the desired basis weight of 70 g/m². Subsequently, the film is subjected to convective drying in a slot die drier. The temperatures of the 3 drier zones, each of length 1 m, are 100, 80 and 60° C. in sequence in coating direction.

The wound roll is removed from the winder and mounted in the unwinder in order to coat the third lamina thereon. In this subsequent step, application solution D is initially charged in the box applicator and applied to the carrier material already coated with C and B at a belt speed of 0.5 m/min. By means of contactless online layer thickness measurement based on ultrasound absorption (MeSys GmbH, USM-200), the doctor blade gap is varied until attainment of the desired basis weight of 40 g/m². Subsequently, the film is subjected to convective drying in a slot die drier. The temperatures of the 3 drier zones, each of length 1 m, are 100, 80 and 60° C. in sequence in coating direction.

The wound roll is removed from the winder and mounted in the unwinder in order to coat the fourth lamina thereon. In this subsequent step, application solution A is initially charged in the box applicator and applied to the carrier material already coated with C, B and D at a belt speed of 0.5 m/min. By means of contactless online layer thickness measurement based on ultrasound absorption (MeSys GmbH, USM-200), the doctor blade gap is varied until attainment of the desired basis weight of 10 g/m². Subsequently, the film is subjected to convective drying in a slot die drier. The temperatures of the 3 drier zones, each of length 1 m, are 100, 80 and 60° C. in sequence in coating direction.

The carrier material can remain part of the roll for storage or transport and serves as separator. Prior to further use of the tetralaminar C-B-D-A composite as a separate water-soluble foil, the carrier foil has to be removed. This can be effected in a separate step (rewinding from the roll to a new bobbin) or in the processing step itself, for example in pouch production. The foil produced in this way has a basis weight of about 130 g/m² and comprises about 10 g/m² of C, about 70 g/m² of B and about 40 g/m² of D.

### Example 3.2

Tetralaminar Foil C-B-D-A: 1st Layer of Carboxymethyl Cellulose, 2nd Layer of Polymer Composition P1-1), 3rd Layer of Dye Transfer Inhibitor, 4th Layer of Polyvinyl Alcohol

For production of the multilayer foil, a slot die from TSE Troller AG with width 150 mm is used in a coating system from Mathis AG (FIG. 3). The syringe initially charged with the free-flowing polymer composition, the liquid feed and the nozzle are at a controlled temperature of 40° C. Application solution C is applied by means of a syringe pump (Nexus 6000 from Chemyx) at 18.8 mL/min at a belt speed of 0.5 m/min to a siliconized polyester foil (foil thickness 36 μm, Hostaphan® RN 2PRK) as carrier material, and then subjected to convective drying in a slot die drier. The temperatures of the 3 drier zones, each of length 1 m, are 100, 80 and 60° C. in sequence in coating direction.

The wound roll is removed from the winder and mounted in the unwinder in order to coat the second lamina thereon. In this subsequent step, application solution B is applied by means of a syringe pump (Nexus 6000 from Chemyx) at 16.2 mL/min at a belt speed of 1 m/min to the carrier material already coated with C, and then subjected to convective drying in a slot die drier. The temperatures of the 3 drier zones are 100, 80 and 60° C. in sequence in coating direction.

The wound roll is removed from the winder and mounted in the unwinder in order to coat the third lamina thereon. In this subsequent step, application solution D is applied by means of a syringe pump (Nexus 6000 from Chemyx) at 7.5 mL/min at a belt speed of 0.5 m/min to the carrier material already coated with C and B, and then subjected to convective drying in a slot die drier. The temperatures of the 3 drier zones are 100, 80 and 60° C. in sequence in coating direction.

The wound roll is removed from the winder and mounted in the unwinder in order to coat the fourth lamina thereon. In this subsequent step, application solution A is applied by means of a syringe pump (Nexus 6000 from Chemyx) at 4.2 mL/min at a belt speed of 0.5 m/min to the carrier material already coated with C, B and D, and then subjected to convective drying in a slot die drier. The temperatures of the 3 drier zones are 150, 110 and 60° C. in sequence in coating direction.

The carrier material can remain part of the roll for storage or transport and serves as separator. Prior to further use of the tetralaminar C-B-D-A coating as a separate water-soluble foil, the carrier foil has to be removed. This can be effected in a separate step (rewinding from the roll to a new bobbin) or in the processing step itself, for example in pouch production. The foil produced in this way has a basis weight of about 130 g/m² and comprises about 10 g/m² of C, about 70 g/m² of B and about 40 g/m² of D.

### Example 3.3

Tetralaminar Foil A-B-D-A: 1st Layer of Polyvinyl Alcohol, 2nd Layer of Polymer Composition P1-1), 3rd Layer of Dye Transfer Inhibitor, 4th Layer of Polyvinyl Alcohol

For production of the multilayer foil, a dilaminar slot die from TSE Troller AG with width 150 mm is used in a foil casting system with a continuous steel belt (CrNi steel, length 16 m) (FIG. 5). The two syringes initially charged with the free-flowing polymer compositions, the liquid feed and the nozzle are at a controlled temperature of 40° C. Application solution A is fed into the front slot in coating direction via a gear pump (P64627/71023201/1MA-A/6-19 from Gather) at 32.2 mL/min. Application solution B is fed into the rear slot in coating direction via a gear pump (P64627/71023201/1MA-A/6-19 from Gather) at 16.7 mL/min at a belt speed of 2 m/min. Thus, by parallel operation of the two pumps, both polymer compositions are applied simultaneously to the carrier material, in this case a CrNi steel belt, and then subjected to convective drying in a slot die drier. The temperatures, 150° C. in the upper part and 60° C. in the lower part, and the fan output in the drier zones are chosen such that the moisture content of water is <15% by weight when the foil is removed from the steel belt. After the separation of steel belt and foil, the foil is subsequently subjected in separate form to further drying in a convective drier at 60° C. Prior to winding, the foil is cooled to room temperature by means of a chill roll.

In a further step, a dilaminar slot die from TSE Troller AG with width 150 mm is used in a foil casting system with a continuous steel belt (CrNi steel, length 16 m) (FIG. 5). The two syringes initially charged with the free-flowing polymer compositions, the liquid feed and the nozzle are at a controlled temperature of 40° C. Application solution A is fed into the front slot in coating direction via a gear pump (P64627/71023201/1MA-A/6-19 from Gather) at 12.5 mL/min. Application solution D is fed into the rear slot in coating direction via a gear pump (P64627/71023201/1MA-A/6-19 from Gather) at 22.5 mL/min at a belt speed of 1.5 m/min. Thus, by parallel operation of the two pumps, both polymer compositions are applied simultaneously to the carrier material, in this case a CrNi steel belt, and then subjected to convective drying in a slot die drier. The temperatures, 150° C. in the upper part and 60° C. in the lower part, and the fan output in the drier zones are chosen such that the moisture content of water is <15% by weight when the foil is removed from the steel belt. After the separation of steel belt and foil, the foil is subsequently subjected in separate form to further drying in a convective drier at 60° C. Prior to winding, the foil is cooled to room temperature by means of a chill roll.

Subsequently, the D-A foil produced in the second step is laminated or coated onto the dilaminar A-B foil produced in the first step in a coating system from Kroenert (FIG. 6). For this purpose, at a belt speed of 5 m/min, the B surface is moistened with water by an ultrasound nozzle (WideTrack from SonoTek Corporation, nozzle frequency 48 kHz) at a pump rate of 18.0 mL/min (P64627/71023201/1MA-A/6-19 gear pump from Gather). In the coating module, under a pressure of 4 bar, the two foils are joined by a rubberized roll (Shore hardness 80) by joining the B and D layers. The foil produced in this way has a basis weight of about 130 g/m² and comprises an average of about 70 g/m² of B and about 40 g/m² of D.

### Example 3.4

Tetralaminar Foil A-B-C-A: 1st Layer of Polyvinyl Alcohol, 2nd Layer of Polymer Composition P1-1), 3rd Layer of Carboxymethyl Cellulose, 4th Layer of Polyvinyl Alcohol

For production of the multilayer foil, a dilaminar slot die from TSE Troller AG with width 150 mm is used in a foil casting system with a continuous steel belt (CrNi steel, length 16 m) (FIG. 5). The two reservoir vessels initially charged with the free-flowing polymer compositions, the liquid feed and the nozzle are at a controlled temperature of 40° C. Application solution A is fed into the front slot in coating direction via a gear pump (P64627/71023201/1MA-A/6-19 from Gather) at 32.2 mL/min. Application solution B is fed into the rear slot in coating direction via a gear pump (P64627/71023201/1MA-A/6-19 from Gather) at 16.7 mL/min at a belt speed of 2 m/min. Thus, by parallel operation of the two pumps, both polymer compositions are applied simultaneously to the carrier material, in this case a CrNi steel belt, and then subjected to convective drying in a slot die drier. The temperatures, 150° C. in the upper part and 60° C. in the lower part, and the fan output in the drier zones are chosen such that the moisture content of water is <15% by weight when the foil is removed from the steel belt. After the separation of steel belt and foil, the foil is subsequently subjected in separate form to further drying in a convective drier at 60° C. Prior to winding, the foil is cooled to room temperature by means of a chill roll.

In a further step, a dilaminar slot die from TSE Troller AG with width 150 mm is used in a foil casting system with a continuous steel belt (CrNi steel, length 16 m) (FIG. 5). The two reservoir vessels initially charged with the free-flowing polymer compositions, the liquid feed and the nozzle are at a controlled temperature of 40° C. Application solution A is fed into the front slot in coating direction via a gear pump (P64627/71023201/1MA-A/6-19 from Gather) at 16.7 mL/min. Application solution C is fed into the rear slot in coating direction via a gear pump (P64627/71023201/1MA-A/6-19 from Gather) at 37.5 mL/min at a belt speed of 1 m/min. Thus, by parallel operation of the two pumps, both polymer compositions are applied simultaneously to the carrier material, in this case a CrNi steel belt, and then subjected to convective drying in a slot die drier. The temperatures, 150° C. in the upper part and 60° C. in the lower part, and the fan output in the drier zones are chosen such that the moisture content of water is <15% by weight when the foil is removed from the steel belt. After the separation of steel belt and foil, the foil is subsequently subjected in separate form to further drying in a convective drier at 60° C. Prior to winding, the foil is cooled to room temperature by means of a chill roll.

Subsequently, the C-A foil produced in the second step is laminated (by means of thermal joining) or coated (by means of an adhesive) onto the dilaminar A-B foil produced in the first step in a coating system from Kroenert (FIG. 6). For this purpose, at a belt speed of 5 m/min, the polymer composition surface is moistened with water by an ultrasound nozzle (WideTrack from SonoTek Corporation, nozzle frequency 48 kHz) at a pump rate of 18.0 mL/min (P64627/71023201/1MA-A/6-19 gear pump from Gather). In the coating module, under a pressure of 4 bar, the two foils are joined by a rubberized roll (Shore hardness 80) by joining the B and C layers. The foil produced in this way has a basis weight of about 110 g/m² and comprises an average of about 70 g/m² of B and about 10 g/m² of C.

Film Aftertreatment

Films consisting of S1) and optionally S2), on completion of drying or partial drying, can be subjected to further process steps. The stretching of the film (orienting) can be effected during the drying or thereafter; during the operation, the water content and the temperature of the film are monitored and controlled according to the degree of deformation. The orientation of the film is at least uniaxial, and this can be produced by standard methods such as roles or tenter frames, for example on commercially available systems such as Andritz Biax (described in DE 3939721 A1), for example. By means of altered role geometries, it is also possible to produce nonuniformly stretched films. Stretched films show higher mechanical tensile strength compared to their unstretched comparative films. Without being bound to the theory, this arises as a result of alignment of the polymer chains and enhanced interaction thereof.

On completion of drying or partial drying, prior to the winding, the surface can be treated with talc or other substances as separating agents.

In addition, films consisting of S1) to optionally of S2), after drying, orientation etc., can be printed; the films here are rolled by means of rolls along a color-bearing and embossed roller; this transfers the color to the film in the desired pattern. This process can be effected on both sides if desired. It is also possible here to transfer not pigment-containing suspensions but two-dimensional layers of a solution. These solutions may comprise substances which, after drying, constitute a barrier layer against the package contents (e.g. surfactants, builders, solvents, etc.) or else lower the water solubility of the film. The latter can ensure, inter alia, that said films do not go into solution prematurely and already release the package contents in the course of handling of the package.

1. A process for producing a functional water-soluble foil, wherein the water-soluble foil comprises at least one layer S1) comprising a polymer composition P1) obtainable by free-radical polymerization of a monomer composition M1) in the presence of at least one polyether component PE), wherein M1) comprises at least one monomer A) selected from α,β-ethylenically unsaturated mono- and dicarboxylic acids, salts of α,β-ethylenically unsaturated mono- and dicarboxylic acids, anhydrides, of α,β-ethylenically unsaturated mono- and dicarboxylic acids and mixtures thereof, in the presence of at least one polyether component PE) selected from polyetherols having a number-average molecular weight of at least 200 g/mol, mono- and di(C₁-C₆-alkyl) ethers of such polyetherols, surfactants containing polyether groups, and mixtures thereof,
wherein the process comprises the following steps:
(a) preparing an aqueous solution of the polymer composition P1), wherein the aqueous solution may comprise, as well as or in place of water, alcohol such as 2-propanol,
(b) casting the aqueous polymer composition P1) from (a) as a film onto a carrier material,
(c) optionally drying the film after an applying of S1) to the carrier material,
(d) applying a layer S2),
wherein layer S2) comprises at least one polymer P2) which is different than the polymer composition P1) and is selected from
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
copolymers comprising at least one copolymerized maleic monomer selected from maleic acid, maleic anhydride, maleic salts and mixtures thereof and at least one copolymerized C₂-C₈ olefin,
homo- and copolymers of acrylamide and/or methacrylamide,
polyamino acids,
water-soluble or water-dispersible polyamides,
polyalkylene glycols, mono- or diethers of polyalkylene glycols,
polyalkylene oxides, for example polyethylene oxide, and
mixtures thereof,
(e) optionally drying the film after the applying of S2) to the carrier material,
(f) optionally applying one or more further layers S1) and/or S2),
(g) optionally drying the film after the applying of one or more further layers S1) and/or S2) to the carrier material in (f),
(h) drying the foil after the applying of all layers S1) and S2) to the carrier material, wherein layers S1) and/or S2) may be applied in a freely chosen sequence or else simultaneously and in each case optionally dried after every application of one or more layers.

2. The process according to claim 1, wherein at least one of the layers comprises at least one additive.

3. The process according to claim 1, wherein, in step (a), the polymer composition P1) is dissolved in water so as to give a solution of at least about 55% by weight of polymer composition, measured by a total mass of polymer composition P1) and water.

4. The process according to claim 1, wherein the solution is cast onto a carrier material in step (b) by a predosed method.

5. The process according to claim 1, wherein the carrier material from step (b) consists of a material selected from the group consisting of iron alloy, nonwoven, polyvinyl alcohol, (oriented) polypropylene, polyethylene, polyethylene terephthalate, polyvinyl chloride, polystyrene, polytetrafluoroethylene, and polyalkylene glycol.

6. The process according to claim 1, wherein the polymer composition P1) is cast onto the carrier material in step (b) in a polymerized state as an aqueous solution.

7. The process according to claim 1, wherein layer S1) is dried down to a residual moisture content of 15% by weight or less, measured by a total mass of the applied layer S1).

8. The process according to claim 1, wherein the casting in step (b) onto the carrier material is effected at reduced pressure relative to an ambient pressure of a casting device.

9. The process according to claim 1, wherein the carrier material from step (b) has been coated with a composition comprising talc, surfactant, wax, polyolefin, polyethylene, polypropylene, polyvinyl chloride, polystyrene, or silicone.

10. The process according to claim 1, wherein two or more of layers S1) and optionally S2) are applied simultaneously to the carrier material in step (b).

11. The process according to claim 1, wherein an applying of multiple layers is conducted simultaneously by a multilayer predosed method or cascade casting.

12. The process according to claim 1, wherein the carrier material from step (b) is selected from the group consisting of nonwoven, polyvinyl, polyethylene terephthalate, polyvinyl chloride and polyalkylene glycol, and the carrier material, after drying of all applied layers S1) and optionally S2), remains bonded to the functional water-soluble foil.

13. The process according to claim 1, wherein a residual moisture content of the functional water-soluble foil is not more than 15% by weight, based on a total mass of the foil, and this residual moisture content is attained only after the applying of all layers S1) and S2).

14. The process according to claim 1, wherein the functional water-soluble foil comprises at least one layer S1), at least one layer S2), and a total of at least 3 layers.

15. The process according to claim 1, wherein layer S1), at a residual moisture content of not more than 15% by weight, has a thickness of 10 to 200 μm.

16. A water-soluble foil producible according to claim 1.

17. The process according to claim 1, wherein at least one of the layers comprises at least one additive selected from the group consisting of plasticizers, scavengers, further polymers, gas permeability and water vapor permeability modifiers, antistats, lubricants, slip agents, dissolution auxiliaries, dyes, pigments, enzymes, corrosion inhibitors, defoamers, fragrances, thickeners, solubilizers, solvents, pH adjusters, antiredeposition agents, optical brighteners, graying inhibitors, dye transfer inhibitors, active antimicrobial ingredients, antioxidants, UV absorbers, antiyellowing agents, bitter substances and mixtures thereof.

18. The process according to claim 1, wherein the solution is cast onto a carrier material in step (b) by a slot die.

19. The process according to claim 16, wherein an applying of multiple layers is conducted simultaneously by a multislot die.
